(19) United States
(12) Patent Application Publication
(10) Pub. No.: US 2026/0098723 A1
(43) Pub. Date: Apr. 9, 2026

(54) Substrate Misalignment Measurement

(71) Applicant: Teramount Ltd., Jerusalem (IL)

(72) Inventors: Abraham Israel, Jerusalem (IL); Hesham Taha, Jerusalem (IL); Elad Schleifer, Shoham (IL); Lior Rechtman, Jerusalem (IL); Svetlana Golod Tentser, Jerusalem (IL)

(21) Appl. No.: 19/353,753

(22) Filed: Oct. 9, 2025

Related U.S. Application Data
(60) Provisional application No. 63/705,145, filed on Oct. 9, 2024.

(51) Int. Cl. G01B 11/27

(52) U.S. Cl. CPC G01B 11/272

(57) ABSTRACT

Systems, methods, and devices for measuring tilt and/or misalignment of one substrate with respect to a second substrate are disclosed, for example, using thin-film interference. For example, an apparatus may include a substrate having a plurality of pedestals, each having a predefined height. A portion of the plurality of pedestals may be configured to engage and distance the substrate from a second underlying substrate. The plurality of pedestals may be further configured to indicate an alignment of the substrate with the underlying second substrate based on a spectrum of light emitted from the plurality of pedestals.

### CROSS-REFERENCE TO RELATED APPLICATIONS

This application claims the benefit of and priority to U.S. Provisional Application No. 63/705,145, filed on Oct. 9, 2024. The aforementioned application is incorporated herein by reference in its entirety.

### BACKGROUND

Alignment of substrates is important for many fields of technology. Improvements to such metrology have wide potential for applicability.

### SUMMARY

The following summary presents a simplified summary of certain features. The summary is not an extensive overview and is not intended to identify key or critical elements.

Aspects of the present disclosure relate to configuring a substrate to use thin-film interference to measure a misalignment of the substrate. For example, one or more aspects of the present disclosure relate to configuring the substrate to use thin-film interference to measure the misalignment of the substrate by disposing a plurality of pedestals on the substrate. The plurality of pedestals, or a portion thereof, may comprise and/or include predefined heights. The substrate may be configured to be subject to thin film interference. For example, the substrate and/or the pedestals may be substantially transparent to one or more wavelengths of light. For example, the substrate and/or the pedestals may comprise glass. The misalignment may comprise a tilt of the substrate. The tilt of the substrate may comprise a tilt of the substrate with respect to an engaged second substrate. In one or more example configurations, the substrate may comprise a glass substrate, and the second substrate may comprise a silicon substrate.

One or more additional aspects of the present disclosure relate to configuring the plurality of pedestals to reflect predetermined wavelengths of light based on a distance of the plurality of the pedestals from the second substrate. The predetermined wavelengths of light may comprise substantially similar wavelengths of light for the plurality of pedestals. Additionally, or alternatively, the predetermined wavelengths of light may be different for a portion of the plurality of pedestals.

In one or more examples of the present disclosure, the plurality of pedestals may comprise substantially similar heights. Additionally, or alternatively, a portion of the plurality of pedestals may comprise different heights.

One or more additional aspects of the present disclosure relate to configuring the pedestals to emit and/or reflect detectable wavelengths of light based on a distance of the pedestals from a second substrate.

### BRIEF DESCRIPTION OF DRAWINGS

A more complete understanding of aspects described herein and the advantages thereof may be acquired by referring to the following description in consideration of the accompanying drawings, in which like reference numbers indicate like features and/or like named features may indicate like features, and wherein:

FIGS. 1A-1C depict portions of example substrates for use in misalignment measurement.

FIGS. 2A-2E depict example substrate packages.

FIG. 3 depicts an example ray diagram.

FIGS. 4A and 4B. FIGS. 4A and 4B depict the intensity of light for two different wavelengths as a function of distance

FIG. 5A depicts an example substrate package.

FIG. 5B depicts an example adhesive layer of the substrate package of FIG. 5A

FIG. 6A depicts a cross-section in the x-z plane of an example substrate package of a substrate engaged with a second underlying substrate.

FIG. 6B depicts a top view in the x-y plane of the substrate package with an example emitted/reflected light pattern from the pedestals of the substrate of FIG. 6A.

FIG. 7A depicts a cross-section in the x-z plane of an example substrate package of a substrate engaged with a second underlying substrate.

FIG. 7B depicts a top view in the x-y plane of the substrate package of FIG. 7A with an example emitted/reflected light pattern from the pedestals.

FIG. 8A depicts a cross-section in the x-z plane of an example substrate package of a substrate engaged with a second underlying substrate.

FIG. 8B depicts a cross-section in the y-z plane of the example substrate package of FIG. 8A.

FIG. 9A depicts a cross-section in the x-z plane of an example substrate package of a substrate engaged with a second underlying substrate.

FIG. 9B depicts a top view in the x-y plane of the substrate package of FIG. 9A with an example emitted/reflected light pattern from the pedestals.

FIG. 10A depicts across-section in the x-z plane of an example substrate package of a substrate engaged with a second underlying substrate.

FIG. 10B depicts a top view in the x-y plane of the substrate package of FIG. 10A with an example emitted/reflected light pattern from the pedestals.

FIG. 11A depicts a cross-section in the x-z plane of an example substrate package of a substrate engaged with a second underlying substrate.

FIG. 11B depicts a top view in the x-y plane of the substrate package of FIG. 11A with an example emitted/reflected light pattern from the pedestals.

FIG. 12A depicts a cross-section in the x-z plane of an example substrate package of a substrate engaged with a second underlying substrate.

FIG. 12B depicts a top view in the x-y plane of the substrate package of FIG. 12A with an example emitted/reflected light pattern from the elongate pedestal.

FIG. 13A depicts a cross-section in the x-z plane of an example substrate package of a substrate engaged with a second underlying substrate.

FIG. 13B depicts a top view in the x-y plane of the substrate package of FIG. 13A with an example emitted/reflected light pattern from the elongate pedestals.

FIGS. 14A-E depict various systems and methods for measuring substrate alignment/misalignment.

FIG. 15 depicts an example method associated with substrate misalignment detection.

FIG. 17 shows example elements of a computing device that may be used to implement any of the various devices described herein, including, for example, analysis instrument, and/or any computing device described herein

### DETAILED DESCRIPTION

The accompanying drawings, which form a part hereof, show examples of the disclosure. It is to be understood that the examples shown in the drawings and/or described herein are non-exclusive and that there are other examples of how the disclosure may be practiced.

Metrological methods for measuring alignment/misalignment of substrates have wide applicability. However, existing technologies have their drawbacks. For example, mechanical profilometers may be slow, the surface probing has the potential to damage delicate surfaces/devices, and it is a difficult method to scale. Other metrological methods include, for example, the use of a confocal microscope. However, like other metrological methods, alignment/misalignment measurement using a confocal microscope may be slow, may be limited to small areas (e.g., chip-level measurements), may not be suitable for large scale production, and may be costly. Other methods include, for example, using a white light interferometer. However, like other metrological methods, alignment/misalignment detection using white light interferometry may be slow, costly, and may encounter issues with measuring transparent layers.

The present disclosure describes apparatuses, systems, and methods for measuring alignment/misalignment, for example, misalignment along an axis (e.g., z-axis), tilt, and/or warp of a first substrate, for example, in relation to an underlying second substrate (e.g., a silicon substrate and/or the like). For example, aspects of the present disclosure relate to measuring misalignment of a first substrate using thin-film interference. For example, thin-film interference may be induced and the thin-film interference effect may be leveraged to output (e.g., emit, reflect, etc.) wavelengths of light from a substrate corresponding to an alignment, misalignment, and/or distance between the substrate and the underlying second substrate. The apparatuses and methods of the present disclosure may increase accuracy and efficiency in measuring alignment/misalignment of a substrate engaged with a second substrate. Additionally, using the techniques in the present disclosure, alignment/misalignment measurement of the substrate in relation to the underlying second substrate may be significantly improved with increased speed, accuracy, scalability, a reduced risk of damaging the device, and reduced cost.

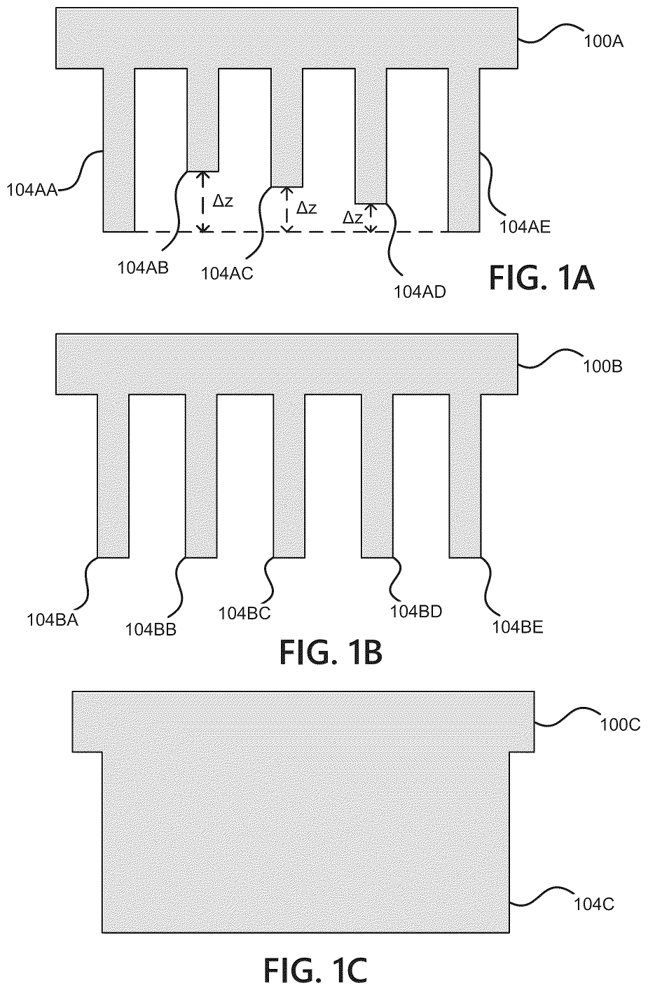

FIGS. 1A-1C depict portions of example substrates 100A-100C (generally, substrate(s) or first substrate(s) 100) for use in misalignment measurement. Referring to FIG. 1A, the substrate 100A (generally, substrate 100) may comprise a substrate or portion of a substrate that is subject to thin-film interference. As non-limiting examples, the substrate 100 (e.g., substrate 100A-100C) may comprise, for example, glass, a glass chip, a semiconductor substrate (e.g., including Silicon (Si), Gallium Arsenide (GaAs), Silicon Carbide (SIC), Sapphire (Al₂O₃), Indium Phosphide (InP), Silicon-on-Insulator (SOI), Gallium Nitride (GaN), Germanium (Ge), Zinc Oxide (ZnO), Telluride (CdTe)), liquid crystal displays (LCDs), photonic crystals, solar cells (e.g., thin-film solar cells), plastic films, photolithography masks and/or other substrates. The portion of substrate 100A depicted in FIG. 1A may comprise a portion of a larger substrate.

The substrate 100A may be substantially transparent to one or more wavelengths of light. The substrate 100A may comprise a plurality of pedestals 104AA-104AE (generally, a plurality of pedestals 104 or pedestal(s) 104). Pedestal 104AA may refer to the first pedestal 104 of substrate 100A, and pedestal 104AE may refer to the fifth pedestal of substrate 100A. Five pedestals of substrate 100A are depicted in FIG. 1A. However, it should be appreciated that substrate 100A may have more or less pedestals 104A. For example, in some example configurations, substrate 100A may include hundreds or even thousands of pedestals depending on, for example, the size of the substrate 100A and the measurement granularity.

The plurality of pedestals 104A may each have predefined (e.g., known) heights. For example, the heights of the pedestals 104A may be predefined (e.g., during production and/or fabrication), and the heights of the pedestals 104A may be known. Some of the plurality of pedestals 104 may have different predefined heights with respect to a surface of the substrate 100A. Alternatively, a first portion of the pedestals 104A may have substantially the same height (e.g., pedestal 104AA and pedestal 104AE) and a second portion of the pedestals 104A (e.g., pedestals 104AB and 104AD) may have different heights. The predefined heights may comprise known height variations (Δz), for example, from a surface (e.g., a lower surface) of the substrate 100A and/or from surfaces (e.g., lower surfaces) of other pedestals 104A. For example, the difference in height (Δz) of pedestal 104AB, 104AC, and/or 104AD from pedestal 104AA and/or pedestal 104AE may be predetermined and/or otherwise known.

The substrate 100A may be configured to engage an underlying substrate (e.g., with which the substrate 100A is assembled). The substrate 100A (e.g., via a portion of the pedestals 104) may be configured to distance the substrate 100A from the underlying second substrate. Engaging and distancing the substrate from the underlying second substrate may allow for improved placement of the substrate, for example, by providing natural alignment features. These natural alignment features may allow, for example, the use of a force-limiting sensor in the case of using pick-and-place machinery. For example, a first portion of the plurality of pedestals 104A (e.g., including pedestals 104AA and 104AE) may be longer than a second portion of the plurality of pedestals 104A (e.g., pedestals 104AB, 104AC, and 104AD). The first portion of the plurality of pedestals 104A may comprise first and last pedestals 104 in a row of the plurality of pedestals 104. Additionally or alternatively, the first portion of the plurality of pedestals 104A may be otherwise distributed in a row of the plurality of pedestals 104. The second portion of the plurality of pedestals 104A may comprise the remaining plurality of pedestals 104A or a portion of the remaining plurality of pedestals 104A. In some example configurations, the predetermined heights of each pedestal 104 in the second plurality of pedestals 104A may differ. Alternatively, the predetermined heights of a portion of the pedestals 104A in the second plurality of pedestals 104 may differ.

FIG. 1B depicts an alternative example substrate 100B for use in misalignment measurement. The example substrate 100B of FIG. 1B may be substantially similar to substrate 100A of FIG. 1A unless otherwise described herein. Referring to FIG. 100B, substrate 100B may comprise a plurality of pedestals 104BA-104BE (generally, pedestal(s) 104B or pedestal(s) 104). The plurality of pedestals 104B may be disposed with predetermined (e.g., known) heights, for example, predefined distances from a surface, for example lower surface or upper surface of the substrate 100B. For example, all of the plurality of pedestals 104B may comprise substantially the same height. In some examples, the plurality of pedestals 104B may include the predefined height, and the predefined height may correspond to a design distance between the substrate 100B and an underlying second substrate.

FIG. 1C depicts an alternative example substrate 100C for use in misalignment measurement. Substrate 100C may be substantially similar to substrate 100A of FIGS. 1A and 100B of FIG. 1B unless otherwise explicitly described. The substrate 100C may comprise one or more elongate pedestals 104C (generally, pedestal(s) 104). The elongate pedestals 104C may extend across a distance of the substrate. The elongate pedestal 104C may be used for misalignment detection, for example, as described herein in more detail.

It should be appreciated that unless explicitly described, the substrates 100A, 100B, and 100C of FIGS. 1A-1C may include similar features and may be used in similar ways. Additionally, for ease and clarity of description, different pedestal 104 configurations herein are depicted on different substrates 100. It should be appreciated that a single substrate 100 may include one or more of the pedestal 104 configurations described herein. For example, a single substrate 100 may include a first portion having different predefined height pedestals 104A, a second portion having substantially similar predefined height pedestals 104B, and a third portion comprising elongate pedestal 104C.

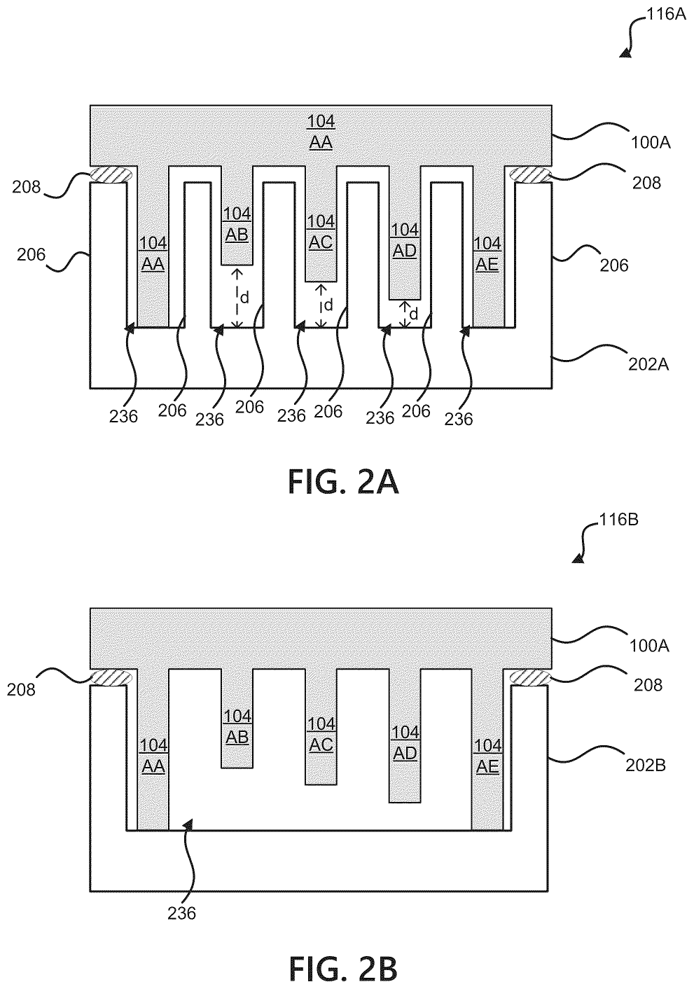

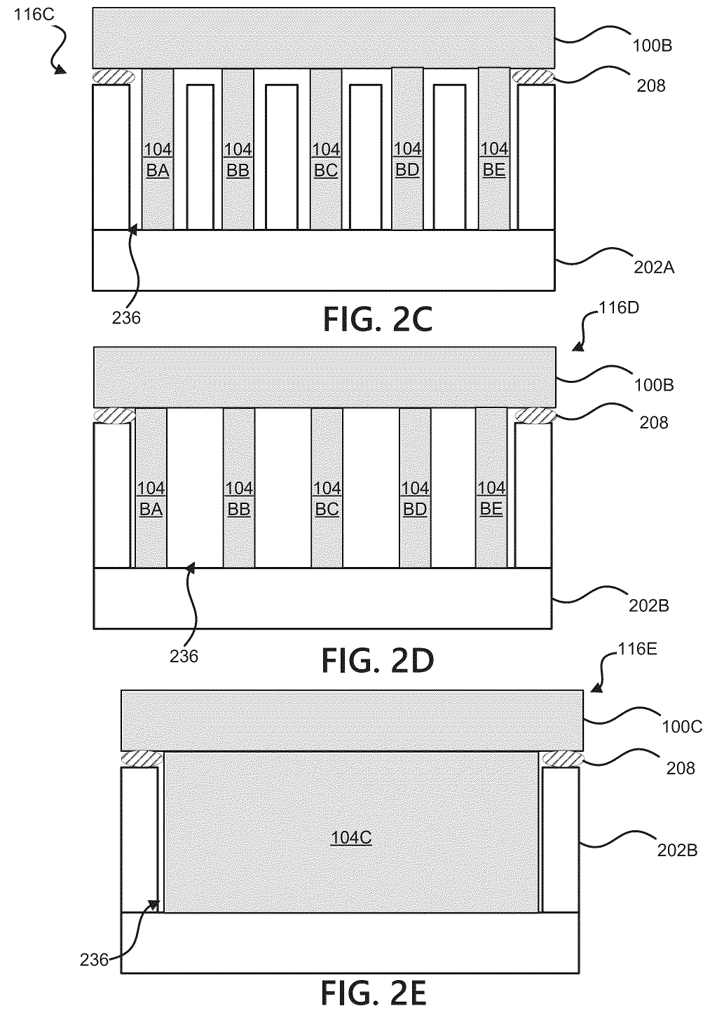

FIGS. 2A-2E depict example substrate packages 116A-116E (generally, substrate package(s) 116). The substrate packages 116A-116E may comprise first substrates 100A-100C engaged with example second substrates 202A-202E (generally, second substrate(s) 202 or substrate(s) 202). FIG. 2A depicts an example of a substrate package 116A in an ideal zero misalignment condition. The substrate package 116A may comprise a first substrate 100A engaged with a second underlying substrate 202A. The substrate 100A and/or the pedestals 104A of the substrate 100A may be configured to use and/or be subject to thin-film interference. For example, if a light is directed at and/or through the first substrate 100A and/or one or more of pedestals 104A, wavelengths of light may be reflected, directed, and/or detectable from the substrate 100A based on the distance of the substrate 100A and/or the pedestals 104A from the underlying second substrate 202A (e.g., from a surface of the underlying second substrate 202A). Accordingly, referring to FIG. 2A, if light is incident on substrate 100A, due to the effects of thin-film interference, one or more wavelengths of light may be reflected and detectable from pedestal 104AA, pedestal 104AB, pedestal 104AC, and pedestal 104AD. As described in more detail herein, the different sized air gaps (e.g., (d) in FIG. 2) between the different pedestals 104A and the second underlying substrate 202A may cause different light interference patterns. The different light interference may cause different wavelengths and/or colors of light to be reflected from the different pedestals 104. The substrates 100 (e.g., substrate 100A), the second underlying substrates 202 (e.g., substrate 202A), and/or detections systems described herein may be configured to use this interference to detect alignment/misalignment of the substrate 100 with the underlying second substrate 202

The second underlying substrate 202A may comprise a plurality of z-stops 206. The z-stops 206 may be formed as voids and/or cavities 236 in the second underlying substrate 202A. The cavities 236 may be formed by etching the underlying substrate 202A. The z-stop cavities 236 may be geometrically correspondingly configured to a corresponding pedestal 104 (e.g., a pedestal placed into the void if the substrate 100 is packaged with the second underlying substrate 202). The substrate 100A and the second substrate 202A may be configured such that the pedestals 104 are disposed in a corresponding z-stop cavity 236 upon installation and engagement of the first substrate 100A with the second underlying substrate 202A. The z-stops 206 may be configured to ensure and/or facilitate alignment of the first substrate 100A with the second substrate 202A. For example, assuming a zero-misalignment condition, the z-stops 206 may be configured to distance the first substrate 100A from the second substrate 202A.

FIG. 2B depicts an alternative example of substrate 100A engaged with an underlying second substrate 202B. FIG. 2A depicts a second underlying substrate 202A having a plurality of end stops. Referring to FIG. 2B, the substrates 100A and systems of the present disclosure may be used for misalignment measurement with fewer z-stops 206. For example, the second substrate 202B may comprise a single z-stop cavity 236 engaging a plurality of pedestals 104. Additionally or alternatively, the first substrate 100A and/or the second underlying substrate 102B may be configured such that, if engaged, a plurality of pedestals 104 (e.g., 104A-104E) are disposed in a single z-stop cavity 236.

FIG. 2C depicts an example substrate package 116C comprising an example substrate 100B having substantially similar length pedestals 104B engaged with a second underlying substrate 202A having a plurality of z-stops 206. In the substrate package 116C of FIG. 2C, each pedestal 104B is disposed in a corresponding z-stop cavity 236.

FIG. 2D depicts an example substrate package 116D comprising an example substrate 100B having a plurality of substantially similar length pedestals 104B engaged with a second underlying substrate 202B. In the substrate package 116D of FIG. 2D, a plurality of pedestals 104B are disposed in a single z-stop cavity 236.

FIG. 2E depicts an example substrate package 116E comprising an example substrate 100C having elongate pedestals 104C engaged with a second underlying substrate 202B. In the substrate package 116E of FIG. 2E, the elongate pedestal 104C is disposed in a z-stop cavity 236.

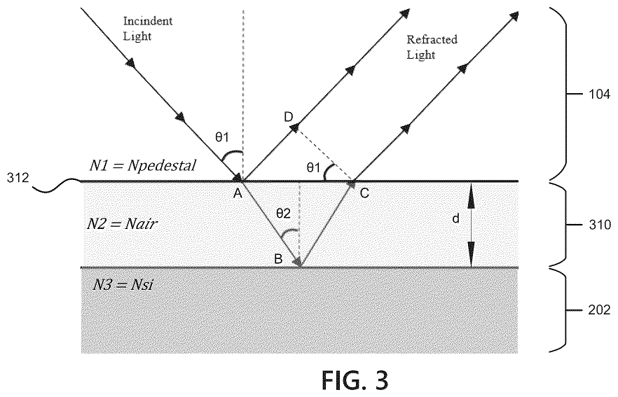

FIG. 3 depicts an example ray diagram. Referring to FIG. 3, as described, the measurement and alignment/misalignment analysis may be used and/or be based on thin-film interference. The pedestals 104 (e.g., pedestals 104 of FIGS. 2A-2E) of the substrates 100 (e.g., substrates 100A-100C) may contact or not contact the second underlying substrate 202 (e.g., 202A and 202B). As described, the second underlying substrate 202, may comprise, as a non-limiting example, a silicon substrate. In examples where the pedestals 104 do not contact the second underlying substrate, the pedestals 104 may not contact the second underlying substrate 202 either 1) because the pedestal 104 is designed such that an air gap 310 (also referenced herein as “(d)”) is formed when the substrate 100 and underlying substrate are engaged (see, e.g., substrate 100A of FIGS. 2A and 2B); and/or 2) misalignment in the z-axis of the first substrate 100 and the second substrate 202 causes an air gap 310 between a pedestal 104 and a second underlying substrate 202. As described, the substrate 100 and the pedestal 104 may be substantially transparent to one or more wavelengths of light. Additionally or alternatively, at least the region of the substrate 100 over the pedestals may be substantially transparent (e.g., even if other portions of the substrate 100 are not transparent) to one or more wavelengths of light.

Referring to FIG. 3, light may be incident upon the substrate 100 and/or pedestal. The light may propagate through the pedestal 104 and the air gap 310. The light may reflect off of the surface of the underlying second substrate 202. Because the pedestals 104 are substantially transparent to the light, the light reflected from the surface of the second underlying substrate 202 and passing back through the pedestal 104, may interfere with light reflected from a surface of the pedestal 312. The resulting interference pattern depends on the width (d) of the air gap 310 and the wavelength of the incident light. Referring to the ray diagram, optical path difference (OPD) may be calculated using the following equation:

$$OPD = {n}_{2} ( \overline{AB} + \overline{BC} ) - {n}_{1} ( \overline{AD )} , where \overline{AB} = \overline{BC} = \frac{d}{cos ( {θ}_{1} )} ,$$

$$\overline{AD} = 2 d tan ( {θ}_{2} ) sin ( {θ}_{1} ) .$$

$$Using Snell ’ s law , OPD = {n}_{2} ( \frac{d}{cos ( {θ}_{1} )} ) - 2 d tan ( {θ}_{2} ) sin ( {θ}_{1} ) = 2 {n}_{2} d cos ( {θ}_{2} ) .$$

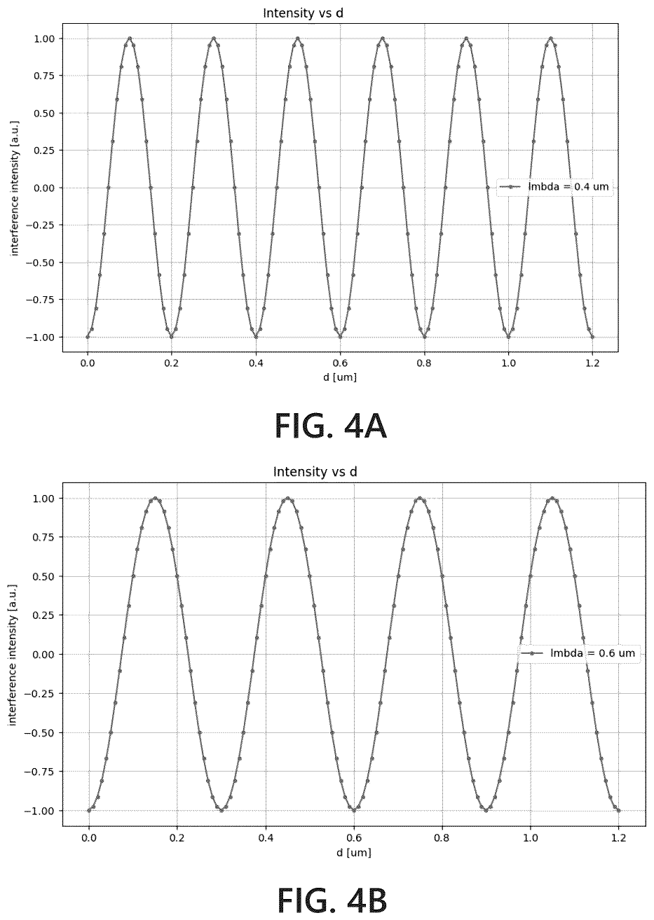

This may be understood with additional reference to FIGS. 4A and 4B. FIGS. 4A and 4B depict the intensity of light for two different wavelengths as a function of air-gap distance. The distance may comprise, for example, the width (d) of the air gap 310. Intensity may be measured using arbitrary units (a.u.). The wavelength of the incident light can be controlled, for example, using filters or other wavelength control techniques. Accordingly, the width (d) of the air gap 310 can be determined based on the detected light following interference. A difference from an expected air gap 310 width (d) or an air gap being detected where an air gap 310 is not expected (e.g., if a pedestal 104 is expected to contact the surface of the second underlying substrate 202 in a zero-misalignment condition), may indicate alignment and/or misalignment of the first substrate 100 in relation to the second underlying substrate 202. Additionally, the determination of the width (d) of the air gap 310 may be used to determine the extent of misalignment.

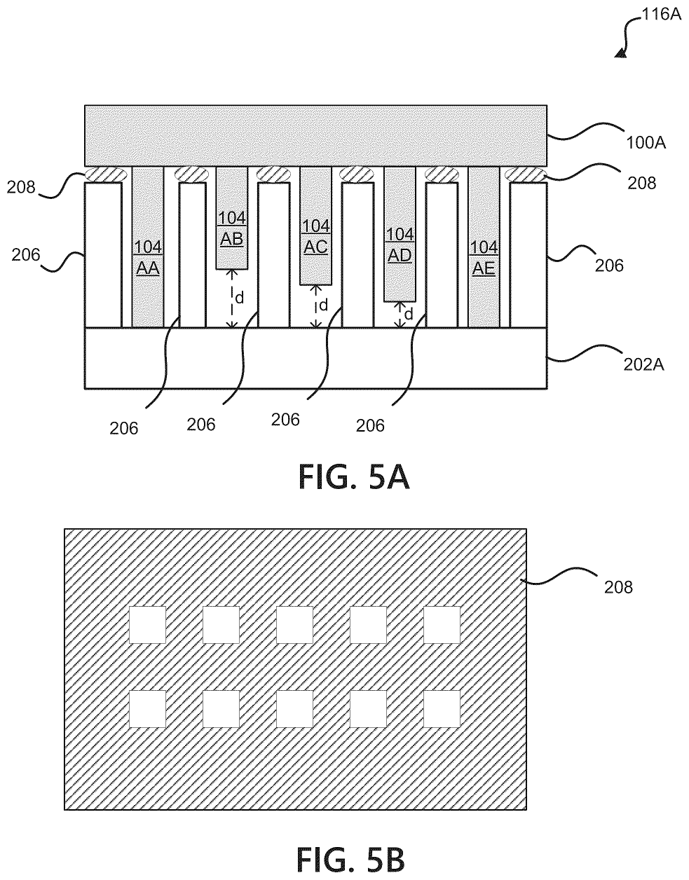

FIG. 5A depicts an example substrate package 116A. FIG. 5B depicts an example adhesive layer 208 of the substrate package 116A of FIG. 5A. The substrate package 116A may comprise a first substrate 110A engaged with a second underlying substrate 202A. The substrate 100A may be adhered (e.g., affixed) to the second underlying substrate 202A, for example, via adhesive layer 208. The adhesive layer 208 may comprise, for example, epoxy resins, silicone adhesives, acrylic adhesives, polyimide adhesives, anisotropic conductive adhesives (ACAs), UV-curable adhesives, etc. Referring to FIGS. 5A and 5B, as described herein, aspects of the present disclosure may leverage the air gap between the substrate 100 and the underlying second substrate 202 to induce thin-film interference, detect a resultant wavelength or color, and determine (e.g., based on the detected wavelengths or colors) an alignment/misalignment of the substrate 100. It may be advantageous to avoid adhesive between the pedestals 104 and the second underlying substrate. Accordingly, in some example configurations, substrate packages 116 of the present disclosure may comprise adhesive 208 in regions (e.g., all regions or portions of all regions) other than beneath the pedestals 104.

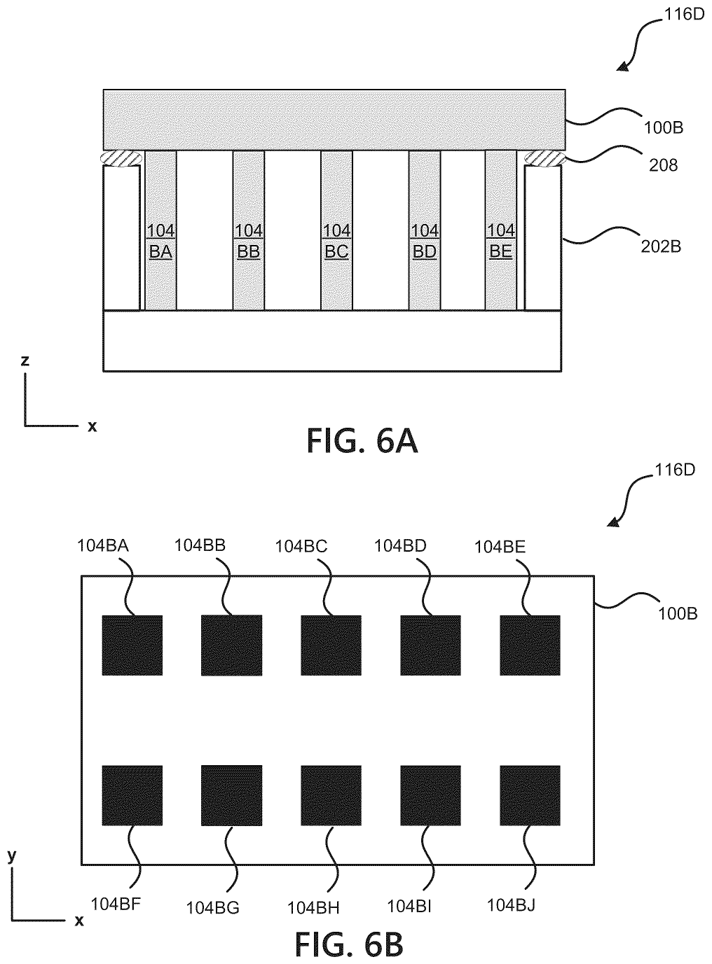

FIG. 6A depicts a cross-section in the x-z plane of an example substrate package 116D of a substrate 100B engaged with a second underlying substrate 202B. FIG. 6B depicts a top view in the x-y plane of the substrate package 116D with an example emitted/reflected light pattern from the pedestals 104 of the substrate 100B of FIG. 6A. FIG. 6A depicts a first substrate 100B having a plurality of pedestals 104B of substantially similar lengths in a zero-misalignment condition. It is to be understood that the example of FIGS. 6A and 6B depict an example substrate having two rows of five (e.g., five columns) pedestals 104. Differently configured substrates 100 may comprise more (e.g., 3, 4, 5, 6, etc.) or less (e.g., 1) rows of pedestals 104. Additionally or alternatively, differently configured substrates 100 may comprise more (e.g., 6, 7, 8, 9, etc.) or fewer (e.g., 2, 3, 4) columns of pedestals 104. Additionally or alternatively, FIGS. 6A and 6B depict the substrate 100B comprising pedestals 104 arranged in columns and rows; it should be understood that the pedestals 104 of other example substrates 100 may be differently configured. For example, the pedestals 104 may be variously distributed across the substrate 100B.

Referring to FIGS. 6A and 6B, as described herein, light may be directed to and made incident upon the substrate 100B. Each pedestal 104B (e.g., 104BA-104BJ) may reflect and/or emit one or more detectable wavelengths and or colors of light therefrom. Differences in color may arise as a result of and/or be caused by a difference in air gap (d) between the pedestals 104B and the underlying second substrate 202B. FIG. 6A depicts a substrate package comprising first substrate 100B, having a plurality of substantially similarly length pedestals 104B in an ideal zero-misalignment condition. As depicted in FIG. 6B, such an ideal configuration may result in substantially the same or similar wavelengths/colors emitted/reflected from each of the plurality of similar height pedestals 104B. As will be discussed herein in more detail, it may be appreciated that a misalignment condition between the first substrate 100B and the second substrate 202B may cause different air gap widths (d) under some of the plurality of pedestals 104B. This difference in air gap width may cause a difference in detectable reflected/emitted wavelengths/colors. These wavelength/colors and/or color map of all of the pedestals 104B may be correlated to a misalignment, and substrate 100B misalignment may be determined.

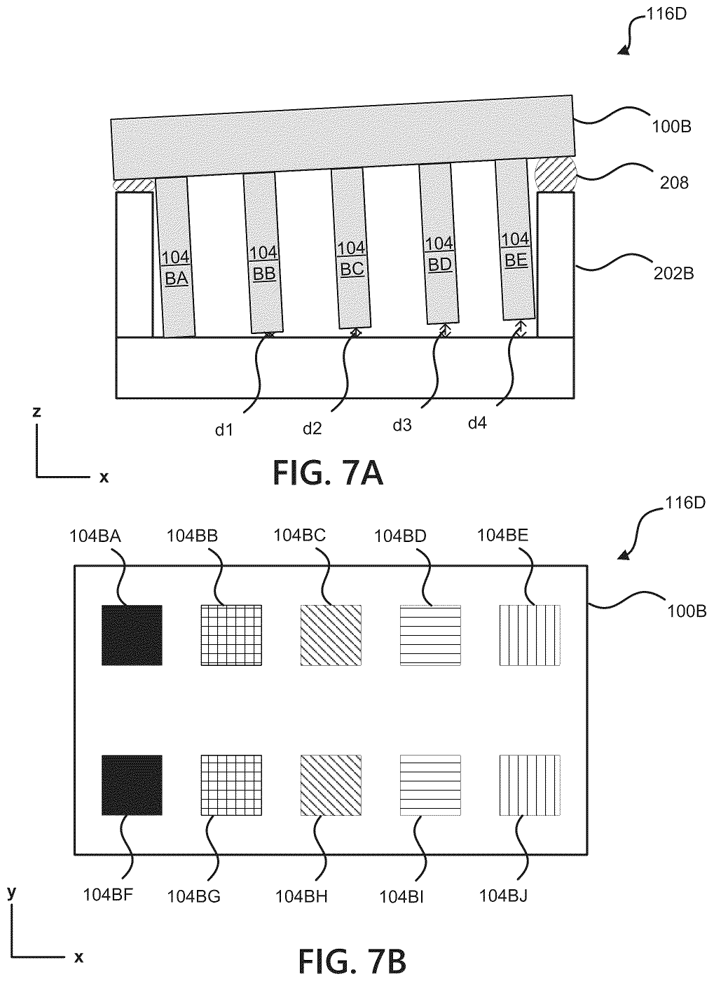

FIG. 7A depicts a cross-section in the x-z plane of an example substrate package 116D of a substrate 100B engaged with a second underlying substrate 202B. FIG. 7B depicts a top view in the x-y plane of the substrate package 116D of FIG. 7A with an example emitted/reflected light pattern from the pedestals 104B. FIGS. 7A and 7B depict examples of misalignment (e.g., tilt) in the x-z plane between the first substrate 100B and the second underlying substrate 202A. In FIG. 7B, different resulting detectable wavelengths/colors (e.g., based on thin-film interference), for example, following incidence of light, are depicted as different example patterns.

Additional understanding may be gained by comparing FIGS. 6A and 6B, depicting an ideal zero-misalignment condition, to FIGS. 7A and 7B, depicting a misalignment condition (e.g., tilt in the x-z plane). Referring to FIGS. 6A-6B, in the zero-misalignment condition, because pedestals 104B are substantially the same height, and because all of the plurality of pedestals 104B are engaged with a surface of the underlying second substrate 202B, interference will not be detectable, and the colors/wavelengths of detectable/reflected light from the plurality of pedestals 104B are about or substantially the same. Referring now to FIGS. 7A and 7B, the depicted example misalignment condition may cause a difference in the air gap width (d) between a portion of the pedestals 104B and the second underlying substrate. For example, the example misalignment condition of FIGS. 7A-7B results in a first air gap between pedestal 104BE and the second underlying substrate 200B, and a second air gap between pedestal 104BC and the second underlying substrate 200B, wherein the width (d4) of the first air gap is larger than the width (d2) of the second air gap. Referring to FIG. 7B, the different air gap widths (d) may produce and/or cause different detectable wavelengths/colors of light (depicted as different patterns in FIG. 7B) from the different pedestals 104 (e.g., from pedestal 104BE and pedestal 104BB), for example, based on thin-film interference. With the wavelength of the incident light being known, and with the reflected wavelengths being determined (e.g., detected), the widths (d) of the air gap beneath each pedestal 104B may be determined (e.g., calculated). In this manner, based on the determined air gap widths (d) beneath the various pedestals 104B, a misalignment of the first substrate 100B in relation to the second underlying substrate 202B may also be determined. FIGS. 7A-7B depict misalignment in the x-z plane but a zero-misalignment condition in the y-z plane. Accordingly, the air gap width may be substantially similar beneath two pedestals 104B of the same x-coordinate but different y-coordinate (e.g., pedestal 104BB and pedestal 104BG). Accordingly, the wavelength/colors detectable from and/or reflected by the pedestals 104B at the same x-coordinate but different y-coordinate (e.g., in the same column) may be about or substantially similar, as depicted by the same pattern in FIG. 7B.

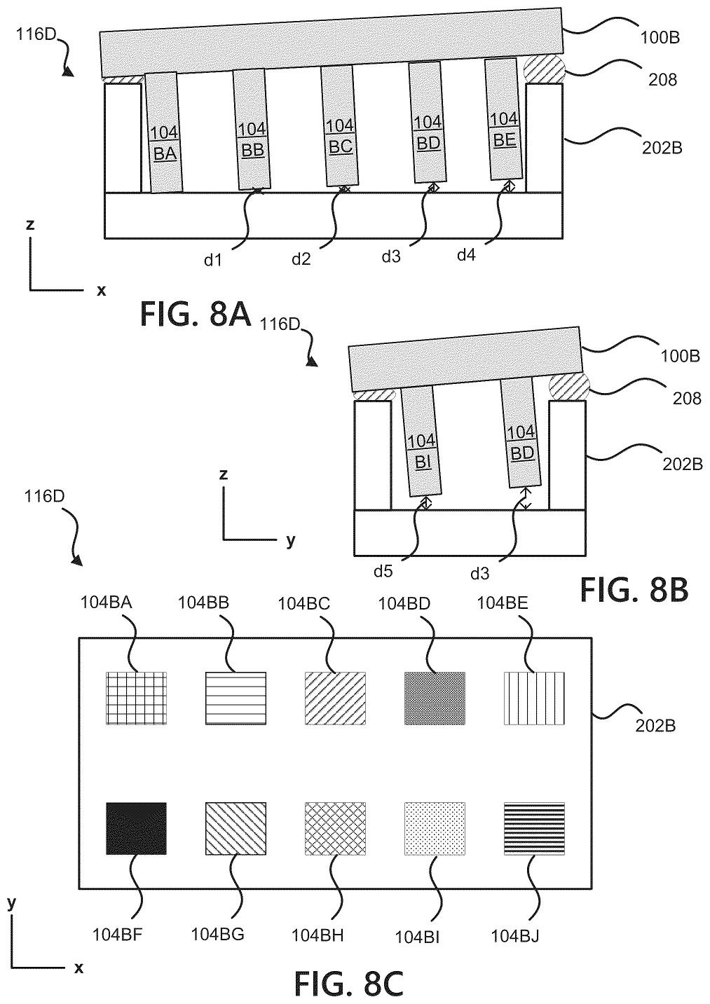

FIG. 8A depicts a cross-section in the x-z plane of an example substrate package 116D of a substrate 100B engaged with a second underlying substrate 202B. FIG. 8B depicts a cross-section in the y-z plane of the example substrate package 116D of FIG. 8A. FIG. 8C depicts a top view in the x-y plane of the substrate package 116D of FIGS. 8A and 8B with an example emitted/reflected light pattern from the pedestals 104B. FIGS. 8A-8C depict examples of misalignment (e.g., tilt) in the x-z plane (e.g., as depicted in FIG. 8A) and in the y-z plane (e.g., as depicted in FIG. 8B) between the first substrate 100B and the second underlying substrate 202B. In FIG. 8C, different resulting detectable/reflected wavelengths/colors (e.g., based on thin-film interference), following incidence of light, are depicted as different example patterns. In comparison to FIGS. 7A-7B (with misalignment in the x-z plane and zero-misalignment in the y-z plane), the example of FIGS. 8A-8C introduces misalignment (e.g., tilt) in the y-z plane. Accordingly, unlike the example of FIGS. 7A-7B, pedestals of the same column (e.g., similar x-coordinate but different y-coordinate) may be associated with different air gap widths (d). For example, referring to FIG. 8B, due to misalignment, pedestal 104BD and pedestal 104BI, of the same column, may have different air gap widths (d) between them and the underlying second substrate 202B. Accordingly, following the incidence of light, the different pedestals 104BD and 10BI of the same column may produce, reflect, and/or emit different detectable wavelengths/colors of light. With a known wavelength of the incident light, the width (d) of the air gaps can be determined and/or calculated. Accordingly, the misalignment (e.g., in both the x-z and y-z planes) can be determined (e.g., as described herein).

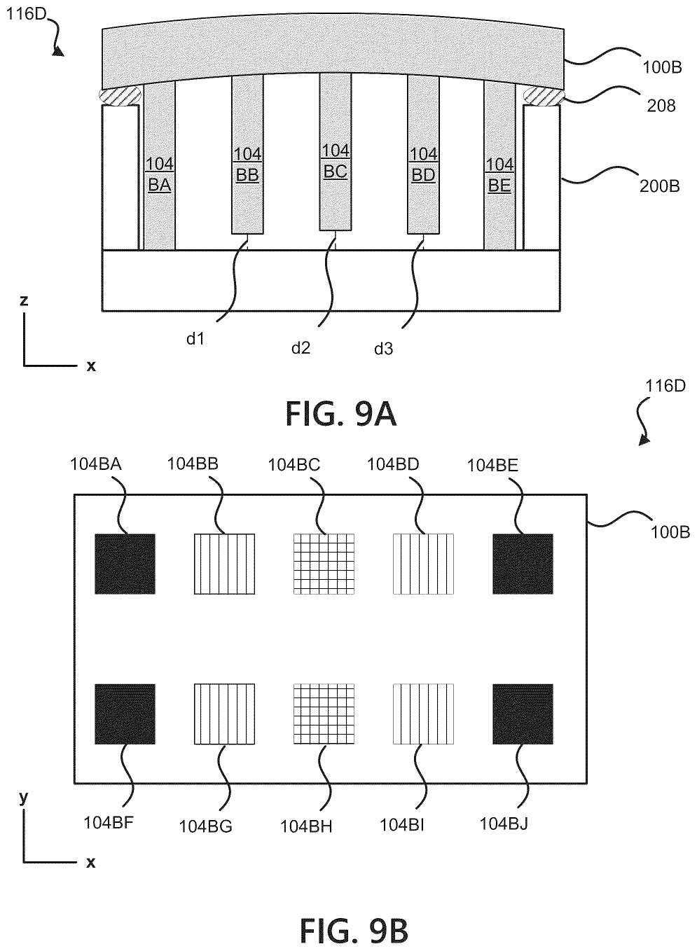

Aspects of the present disclosure may be used to detect other types of misalignment. For example, the apparatuses, systems, and methods of the present disclosure may be used to determine misalignment in the form of warping. FIG. 9A depicts a cross-section in the x-z plane of an example substrate package 116D of a substrate 100B engaged with a second underlying substrate 202B. FIG. 9B depicts a top view in the x-y plane of the substrate package 116D of FIG. 9A with an example emitted/reflected light pattern from the pedestals 104B. FIGS. 9A and 9B depict examples of misalignment in the form of warping in the x-z plane between the first substrate 100B and the second underlying substrate 202B. In FIG. 9B, different resulting detectable wavelengths/colors (e.g., based on thin-film interference), following incidence of light, are depicted as different example patterns.

Referring to FIGS. 9A and 9B, the depicted example misalignment condition (e.g., warping) may cause a difference in the air gap width (d) between a portion of the pedestals 104B and the second underlying substrate 202B. For example, the example misalignment condition of FIGS. 9A and 9B results in a first air gap (d1) between pedestal 104BB and the second underlying substrate 202B, and a second air gap (d2) between pedestal 104BC and the second underlying substrate 202B, wherein the first air gap width (d1) is smaller than the second air gap width (d2). Referring to FIG. 9B, this difference in air gap width (d) may produce different detectable/reflected wavelengths/colors of light (depicted as different patterns in FIG. 7B) from the different pedestals 104 (e.g., from pedestal 104BB and pedestal 104BC). With the wavelength of the incident light being known, the air gap widths (d) beneath each pedestal 104B may be determined. In this manner, a misalignment in the form of warping of the first substrate 100B in relation to the second underlying substrate 202B may also be determined. FIGS. 9A-9B depict misalignment in the x-plane but a zero-misalignment condition in the y-z plane. Accordingly, the wavelength/colors detectable from the pedestals 104B at the same x-coordinate but different y-coordinate (e.g., in the same column) may be substantially similar, as depicted by the same pattern in FIG. 9B. It should be appreciated that the features of the present disclosure may additionally or alternatively be used to determine warping misalignment in multiple planes (e.g., x-z and y-z).

It should be appreciated that warping of substrates may happen over time. For example, assuming one or more example substrates and/or substrate packages of the present disclosure are used in computing applications, the substrates 100/packages 116 may be subject to thermal stresses. Such stresses may cause warping over time. It may be desirable to test (e.g., periodically) such substrates 100/packages 116 for warping or other misalignment. For example, if the substrates (e.g., substrate 100 and second underlying substrate 200) are used in an optical coupling application, misalignment may cause optical attenuation. However, it may be costly and time-consuming to remove such substrate packages from large component packages to test on existing metrology devices. The systems, methods, and apparatuses of the present disclosure allow for quick, and efficient testing of such packages 116. Additionally or alternatively, the systems, methods, and apparatuses of the present disclosure may allow for such testing without removing the substrates 100/packages 116 from larger packages and/or installations.

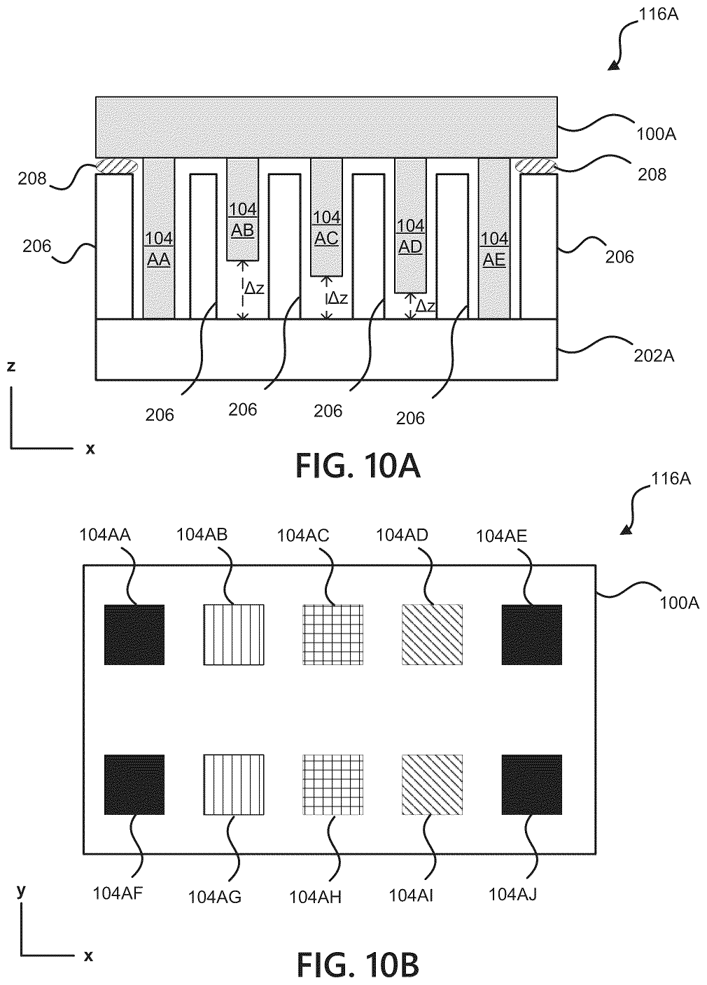

FIG. 10A depicts a cross-section in the x-z plane of an example substrate package 116A of a substrate 100A engaged with a second underlying substrate 202A. FIG. 10B depicts a top view in the x-y plane of the substrate package 116A of FIG. 10A with an example emitted/reflected light pattern from the pedestals 104. FIG. 10A depicts a first substrate 100A having pedestals 104AA-104AE of varying lengths in a zero-misalignment condition. In FIG. 10B, the different wavelengths and/or colors of emitted/reflected light are represented by different cross-hatch patterns. It is to be understood that the example of FIGS. 10A and 10B depict an example substrate having two rows of five (e.g., five columns) of pedestals 104A. Differently configured substrates 100 may comprise more (e.g., 3, 4, 5, 6, etc.) or fewer (e.g., 1) rows of pedestals 104A. Additionally or alternatively, differently configured substrate may comprise more (e.g., 6, 7, 8, 9, etc.) or fewer (e.g., 2, 3, 4) columns of pedestals 104A. Additionally or alternatively, while FIGS. 10A and 10B depict the substrate 100A comprising pedestals 104A arranged in columns and rows, the pedestals 104 of other example substrates 100 may be differently configured. For example, the pedestals 104A may be variously distributed across the substrate 100A.

Referring to FIGS. 10A and 10B and as described herein, light may be directed to and made incident upon the substrate 100A. Each pedestal 104A (e.g., 104AA-104AJ) may reflect and/or emit one or more detectable wavelengths and/or colors of light therefrom. The different colors may be a result of and/or caused by the difference in air gap width (d) between the pedestal 104A and the underlying second substrate 202A. As described herein, the difference in height of the pedestals (Δz) may be known. Thus, the resulting difference in air gap width (d) between the pedestals 104 and the second substrate 202A may be predicted/known for an ideal zero misalignment condition (e.g., as depicted in FIGS. 10A and 10B). With these known values, the expected and/or predicted wavelength(s)/color of light from each pedestal may be known for the zero-misalignment condition. For example, referring to FIGS. 10A and 10B (and assuming zero-misalignment), the pedestals 104AA, 104AE, 104AF, and 104AJ are in contact with the underlying second substrate 202A, therefore the same wavelength/color is reflected, detectable, and/or emitted from each of these pedestals. Similarly, pedestals 104AB and 104AG are disposed (in the zero-misalignment condition) at the same distance from the underlying second substrate 202A. However, pedestals 104AB and 104AG comprise a different Δz from the remaining pedestals 104A. Accordingly, the wavelength/color reflected/emitted from the pedestals 104AB and 104AG is expected to be different from the remaining pedestals 104A. A similar condition may be expected from pedestals 104AC and 104AH, and pedestals 104AD and 104AI. It can be appreciated, that based on the known Δz of the various pedestals 104A, reflected/emitted wavelengths/colors may be expected and/or predicted for a zero-misalignment condition (e.g., as depicted in FIGS. 10A and 10B). For example, a spectrum of wavelengths/colors (e.g., a “fingerprint” or color map) may be predicted or expected to be detectable from the substrate 100B for the zero-misalignment condition. Deviation from the zero-misalignment condition may be detected and determined based on deviation from the expected and/or predicted color map (as described in more detail herein).

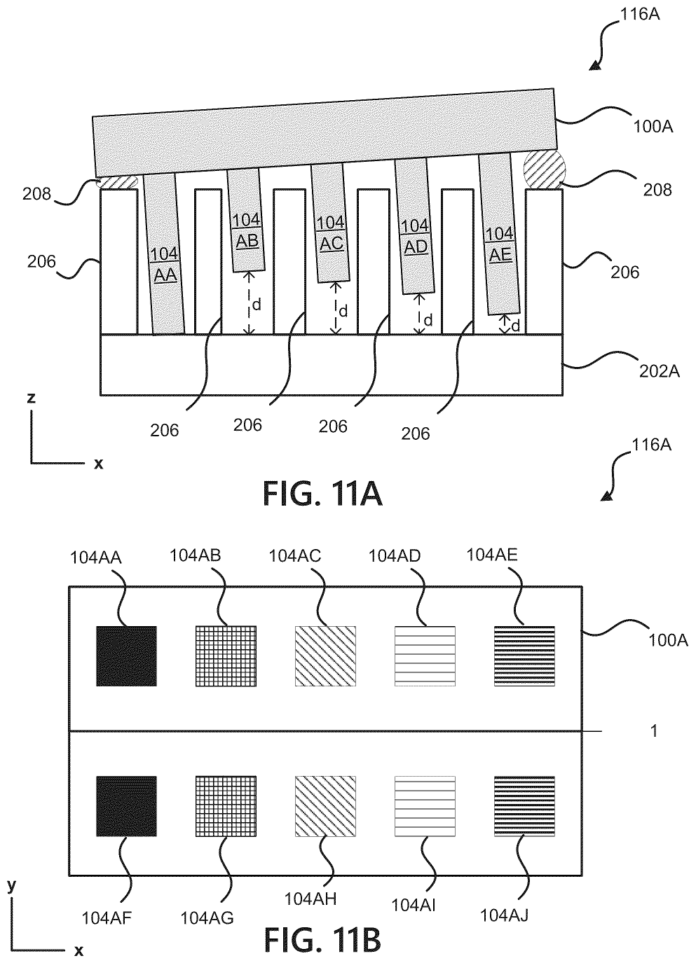

FIG. 11A depicts a cross-section in the x-z plane of an example substrate package 116A of a substrate 100B engaged with a second underlying substrate 202B. FIG. 11B depicts a top view in the x-y plane of the substrate package 116A of FIG. 11A with an example emitted/reflected light pattern from the pedestals 104B. FIGS. 11A and 11B depict examples of misalignment (e.g., tilt) in the x-z plane (but zero-misalignment in the y-z plane) between the first substrate 100B and the second underlying substrate 202A. In FIG. 11B, different resulting detectable wavelengths/colors (e.g., based on thin-film interference), for example, reflected/emitted from the pedestals 104A following incidence of light, are depicted as different example patterns (e.g., different cross-hatch patterns).

Further understanding may be gained by comparing FIGS. 10A and 10B, depicting a zero-misalignment condition, to FIGS. 11A and 11B, depicting a misalignment condition (e.g., tilt in the x-z plane). Referring to FIGS. 10A-10B, in the zero-misalignment condition, because a portion of pedestals 104A are different heights, if light is incident on the substrate 100A, a portion of the different pedestals 104A may reflect/emit different wavelengths/colors of light. In the zero-misalignment condition, the spectrum or wavelength map (e.g., “fingerprint”) produced by, reflected by, and/or detectable from the different pedestals 104A may be predicted due to the known Δz between the different pedestals 104A and known wavelength of incident light.

Referring now to FIGS. 11A and 11B, the depicted example misalignment condition may cause a difference in the air gap width (d) between a portion of the pedestals 104A and the second underlying substrate. The difference in the air gap width (d) may comprise a difference between the expected air gap width (d) in a zero-misalignment condition (e.g., Δz as depicted in FIGS. 10A-10B) and an actual air gap width (d). The width (d) of the air gaps between the pedestals 104A and the second underlying substrate 202A may cause light interference (as described herein) and may result in the production of wavelengths/colors detectable at each pedestal 104 (e.g., based on thin-film interference). Because of the misalignment resulting in air gap widths (d) different from the expected zero misalignment air gap width (d), the resulting detected wavelengths/colors may be different than expected. The actual air gap widths (d) may be determined and/or calculated based on the detected wavelengths/colors. The actual air gap widths (d) can be compared to the expected (e.g., ideal or zero-misalignment) widths (e.g., Δz), and the misalignment (e.g., tilt) may be determined (e.g., calculated). While not depicted, it should be appreciated that, similar to that which is described in relation to FIGS. 8A-8C, the present systems, methods, and apparatuses can be used to detect multi-plane misalignment with the substrate package 116A of FIGS. 10A-11B.

Additionally, it should be appreciated that the different predetermined and known heights and Δz of the pedestals 104A of substrate 100A may provide measurement redundancies. Such redundancies may be used to check and improve accuracy of the alignment/misalignment determinations. For example, referring to FIGS. 10A-11B, in the case of tilt misalignment, for example,

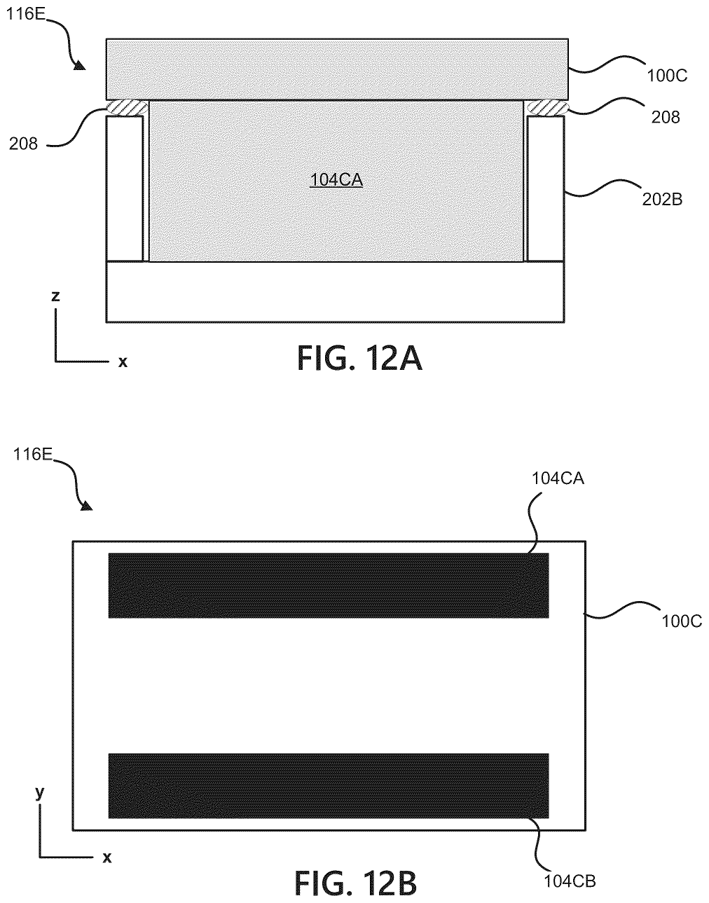

FIG. 12A depicts a cross-section in the x-z plane of an example substrate package 116E of a substrate 100C engaged with a second underlying substrate 202B. FIG. 12B depicts a top view in the x-y plane of the substrate package 116E of FIG. 12A with an example emitted/reflected light pattern from the elongate pedestal 104C. FIG. 12A depicts a first substrate 100C having elongate pedestals 104C in a zero-misalignment condition. It is to be understood that the example of FIGS. 12A and 12B depict an example substrate 100C having two elongate pedestals 104C. Differently configured substrates 100C may comprise more (e.g., 3, 4, 5, 6, etc.) or fewer (e.g., 1) elongate pedestals 104C. Additionally, FIGS. 12A and 12B depict the substrate 100C comprising elongate pedestals 104C arranged in a column, it should be understood that the elongate pedestals 104C of other example substrates 100 may be differently configured (e.g., elongate pedestals 104C may be variously distributed across a substrate 100C). Additionally, FIG. 12B depicts elongate pedestals 104C that are substantially rectangular. In other example configurations, the elongate pedestals may be variously shaped.

Referring to FIGS. 12A and 12B and as described herein, light may be directed to and/or made incident upon the substrate 100C. Each elongate pedestal 104C (e.g., 104CA and 104CB) may reflect and/or emit one or more detectable wavelengths and or colors of light therefrom. Any difference in colors may be produced as a result of and or caused by a difference in air gap width (d) between the region of the elongate pedestal 104C and the underlying second substrate 202B. FIG. 12A depicts a substrate package comprising first substrate 100C, having a plurality of substantially similarly length elongate pedestals 104CA and 104CB, in a zero-misalignment condition. As depicted in FIG. 12B, such an ideal configuration may result in substantially the same or similar wavelengths/colors emitted/reflected from the length of each of the plurality of same height elongate pedestals 104C. As will be discussed herein in more detail, it may be appreciated that a misalignment condition (e.g., a tilt) between first substrate 100C and second substrate 202B may cause a change (e.g., a gradual change) in air gap width (d) across the length of the elongate pedestals 104C. This change in air gap width (d) may produce different and/or changing detectable wavelengths/colors along the length of (or a portion of the length of) the elongate pedestal 104. This change in detectable wavelengths/colors may be correlated to the changing air gap width (d). For example, the air gap width (d) may be determined based on a difference between the expected wavelengths/color and the detected wavelengths/colors from the elongate pedestals 104C. This distance can then be correlated to a misalignment between the first substrate 100C and the second underlying substrate 202B. Additionally, FIGS. 12A and 12B depict an example configuration in which the plurality of elongate pedestals 104CA and 104CB comprise substantially similar heights. In alternative example configurations, different elongate pedestals 104C may comprise different heights and a known or predicted offset (e.g., Δz). The different height elongate pedestals 104C may result in advantageous measurement redundancies, for example, similarly to that which is described with reference to FIGS. 11A and 11B.

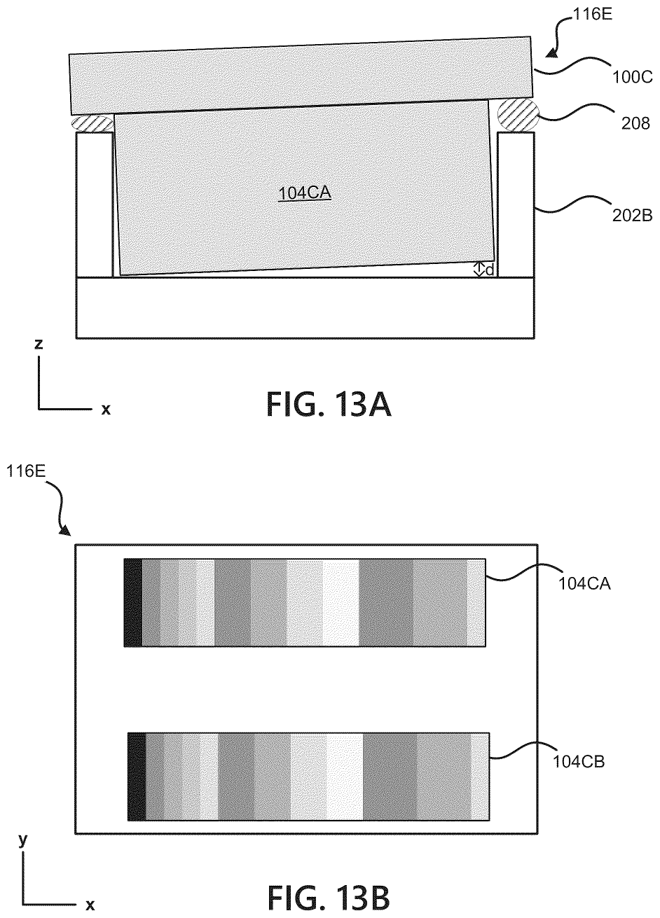

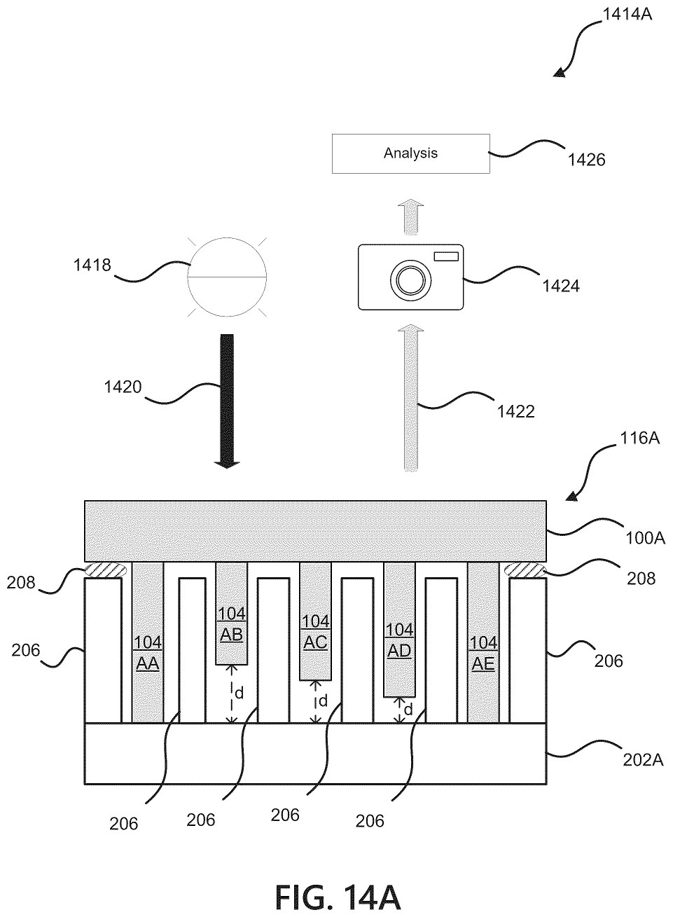

FIG. 13A depicts a cross-section in the x-z plane of an example substrate package 116E of a substrate 100C engaged with a second underlying substrate 202B. FIG. 13B depicts a top view in the x-y plane of the substrate package 116E of FIG. 13A with an example emitted/reflected light pattern from the elongate pedestals 104C. FIGS. 13A and 13B depict examples of misalignment (e.g., tilt) in the x-z plane (but zero-misalignment in the y-z plane) between the first substrate 100C and the second underlying substrate 202B. In FIG. 13B, different resulting detectable wavelengths/colors (e.g., based on thin-film interference), for example, reflected/emitted from the pedestals 104C following incidence of light, are depicted with different shading.

Further understanding may be gained by comparing FIGS. 12A and 12B, depicting a zero-misalignment condition, to FIGS. 13A and 13B, depicting a misalignment condition (in the x-z plane). Referring to FIGS. 12A-12B, in the zero-misalignment condition, because any air gap, or lack thereof, between the substrate 100C and the second underlying substrate 202B may be substantially the same, if light is incident on the substrate 100C, different portions of the elongate pedestals 104C may reflect/emit substantially the same wavelength/colors of light. In the zero-misalignment condition, the spectrum or wavelength map (e.g., “fingerprint”) produced by and/or detectable from the elongate pedestals 104C may be substantially uniform.

Referring now to FIGS. 13A and 13B, the depicted example misalignment condition may cause a difference in the air gap width (d) between different portions of the elongate pedestals 104C and the second underlying substrate 202B. The difference in the air gap width (d) may comprise a difference between the expected width (d) in a zero-misalignment condition (e.g., zero air gap as depicted in FIGS. 12A and 12B) and an actual width (d) of the air gap. The width (d) of the air gap between the elongate pedestals 104C and the second underlying substrate 202B may cause light interference (as described herein) and may result in the production of wavelengths/colors (e.g., different wavelength/colors) detectable along the length of each elongate pedestal 104C (e.g., elongate pedestals 104CA and 104CB) (e.g., based on thin-film interference). The actual air gap widths (d) may be determined and/or calculated based on the detected wavelengths/colors detectable opposite the particular area of air gap. The actual air gap widths (d) can be compared to the expected (e.g., ideal or zero-misalignment), and the misalignment (e.g., tilt) may be determined. While not depicted, it should be appreciated that, similar to that which is described in relation to FIGS. 8A-8C, the present systems, methods, and apparatuses can be used to detect multi-plane (e.g., x-z and y-z) misalignment with the substrate package 116E of FIGS. 13A-13B.

With reference to FIGS. 6A-13B, additional advantages of the present disclosure may be realized. For example, it may be appreciated that existing metrological methods for measuring substrate misalignment, for example, with the use of a mechanical profilometer may be affected by a variance in thickness. For example, even if a first substrate is aligned with a second substrate, if the thickness of the first substrate varies (e.g., due to production defects) the existing metrological methods may cause the misidentification of the substrate thickness variance as a misalignment. Similarly, existing metrological methods, considering only the surface of the first substrate (e.g., with the use of a mechanical profilometer) may not detect warpage of the second underlying substrate. It may be appreciated with reference to the present disclosure that the present systems, apparatuses, and methods may be used to accurately detect misalignment of the first substrate in relation to the second substrate even in the event of a varying thickness first substrate. Additionally, the systems, apparatuses, and method of the present disclosure may detect warpage of the second underlying substrate (which can cause components and/or systems to malfunction).

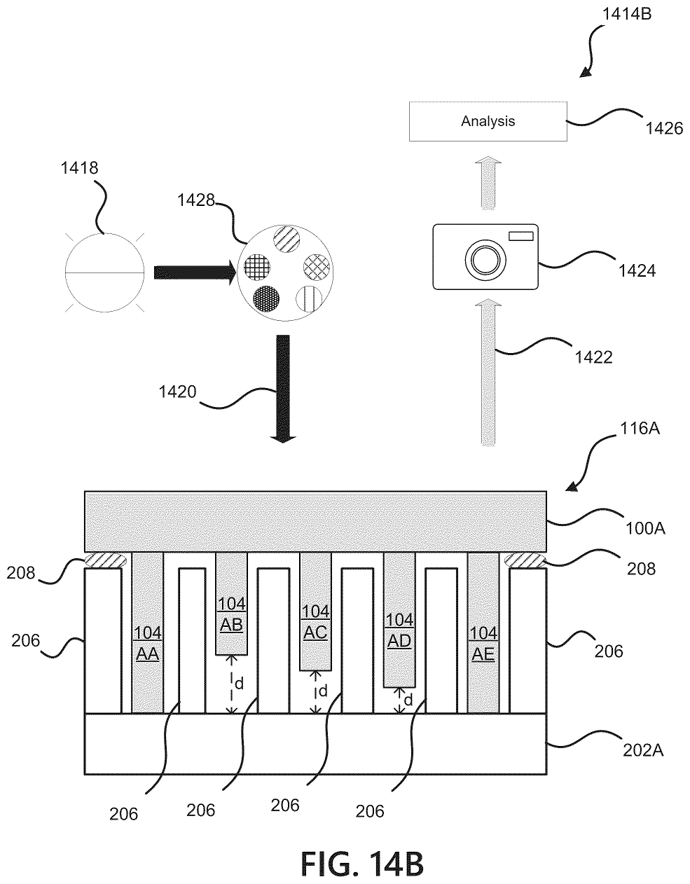

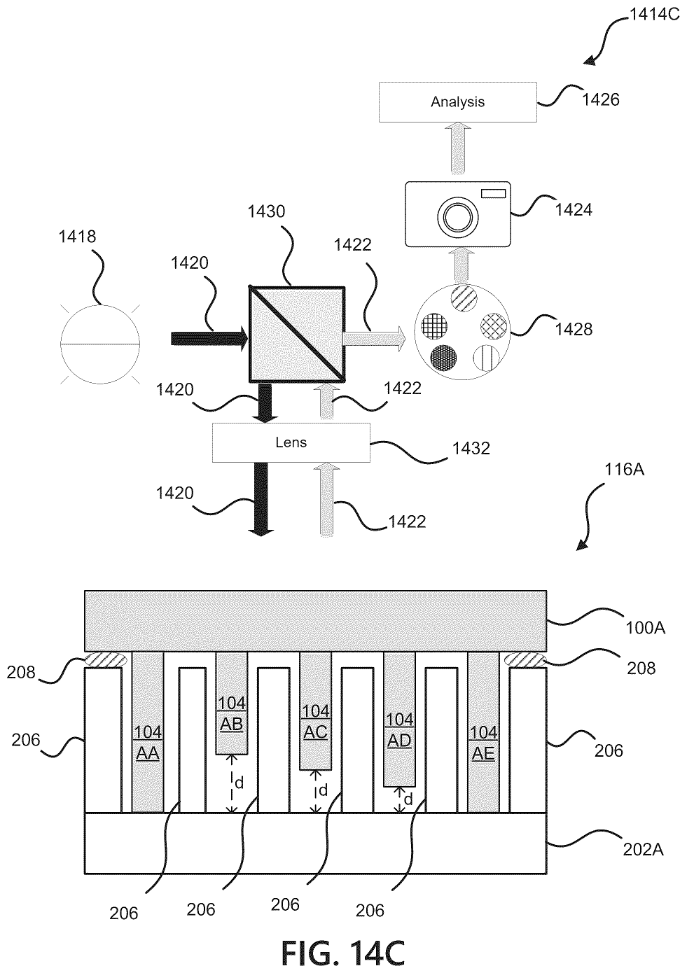

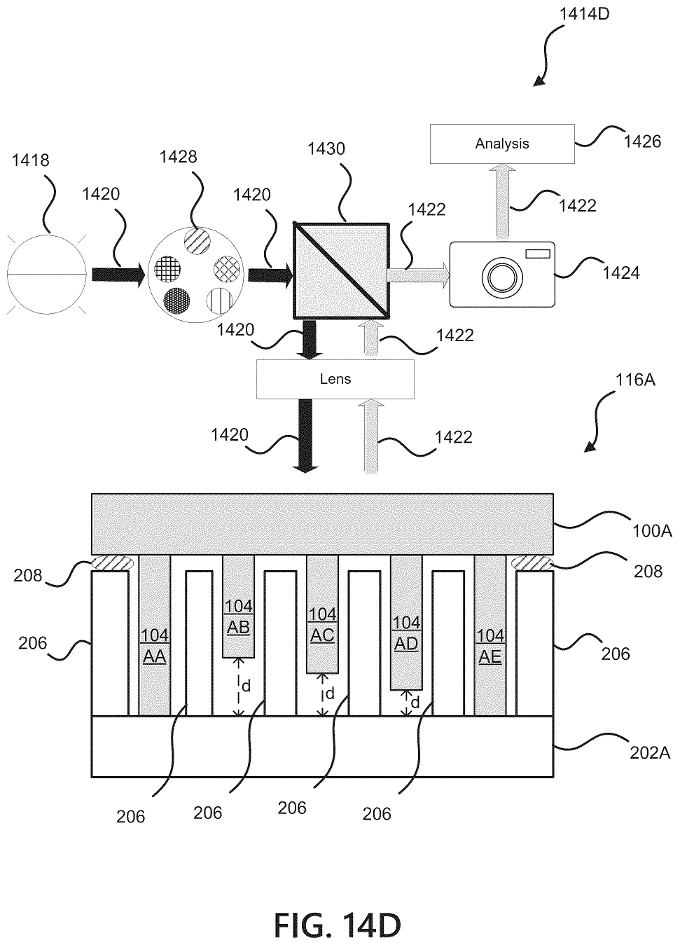

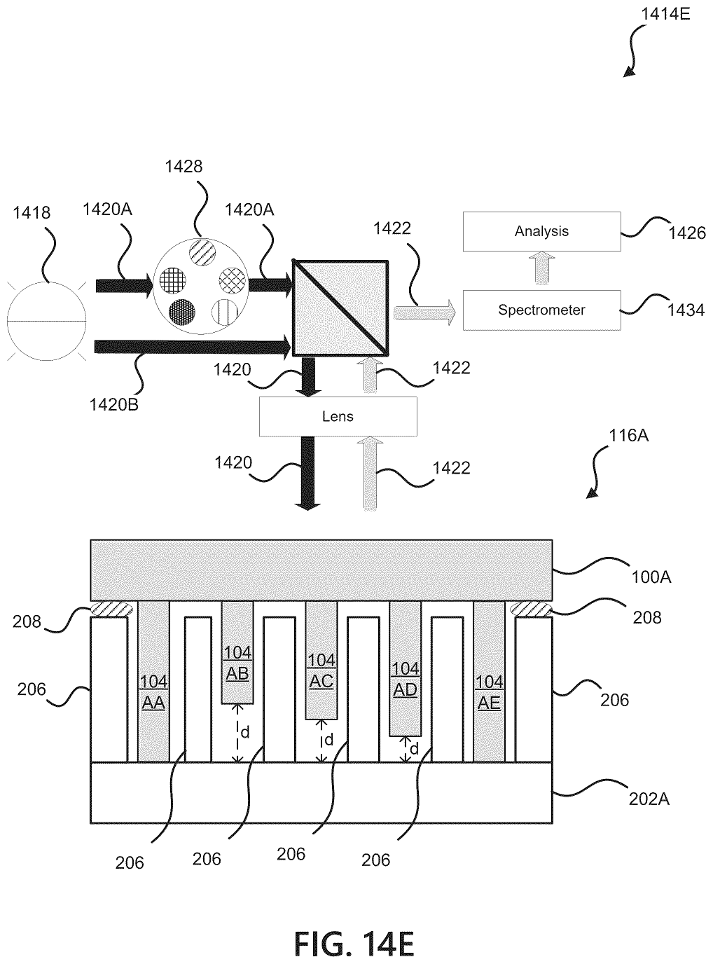

Aspects of the present disclosure further relate to systems and methods for measuring and/or determining alignment and/or misalignment of substrates. FIGS. 14A-E depict various systems and methods for measuring substrate alignment/misalignment. FIG. 14A depicts an example alignment/misalignment detection system 1414A and method for measuring substrate alignment/misalignment. For example, the alignment/misalignment detection system 1414A may comprise a substrate package 116A as described. The substrate package 116A may comprise an example substrate 100 (e.g., substrate 100A) engaged with and/or packaged with a second underlying substrate 202 (e.g., second underlying substrate 202A). Although the example alignment/misalignment detection systems 1414 of FIGS. 14A-14E are depicted as operating with and/or on substrate package 116A, it should be understood that any of the substrate packages described here (e.g., any of the substrate packages 116A-116E) may be used in the alignment/misalignment detection system 1414A-1414E of FIGS. 14A-14E.

Referring to FIG. 14A, the substrate 100A and/or substrate package 116A may be configured to measure the tilt and/or alignment/misalignment of the substrate 100A by using thin-film interference. The alignment/misalignment detection system 1414A (generally, alignment/misalignment detection system 1414) may further comprise a light source 1418. The light source 1418 may produce an incident light (depicted as arrow 1420). The incident light may include one or more wavelengths or colors. The one or more wavelengths may be predetermined. Additionally or alternatively, the light source 1418 may produce light of different wavelengths. Additionally or alternatively, the wavelength of incident light 1420 from the light source 1418 may be varied. The light source 1418 may comprise a wide light source. The incident light 1420 from the light source 1418 may be directed to be incident upon a portion of the substrate 100A and substrate package 116A. The incident light 1420 may pass through the surface layer of substrate 100A, through the pedestals 104A, and to the second underlying substrate 202A.

As described herein, light from incident light 1420 reflecting off of the pedestals may interfere with light reflecting from the second underlying substrate 202A. The degree of interference may be dependent on the air gap width (d) between the pedestals 104A and the second underlying substrate 202A. Reflected light (depicted as arrow 1422) from the pedestals 104A of the substrate package 116A may vary depending on the air gap width (d) between the corresponding pedestal 104A. The reflected light 1422 (e.g., reflected, transmitted, and/or detectable from the substrate package 116A) may be detected and/or captured. For example, alignment/misalignment detection system 1414A may further comprise one or more sensors 1424 (also sensor(s) 1424) (e.g., a digital camera and/or vision system). The one or more sensors 1424 may be connected, for example, through a first connection (e.g., wired, wireless, and/or other connection means) to an analysis instrument 1426 (e.g., a computing device (e.g., computing device 1730) executing, for example, a software, machine learning algorithm(s), and/or other analysis components). Sensor 1424 may capture, scan, and/or detect the substrate package 116A and/or the reflected light 1422, for example, from the pedestals 104A. For example, the sensor 1424 may capture, scan, and/or detect the pattern, or spectrum of reflected light 1422 from the surface of the substrate 100A. The sensor 1424 may send, to the analysis instrument, information corresponding to the captured, scanned, and/or detected/reflected light 1422. The analysis instrument 1426 may process the information from the sensor 1424. For example, the analysis instrument 1426 may process the information from the sensor 1424 to correlate the detected wavelengths, light patterns, and/or spectrum, with distances of air gaps between the pedestals 104 and the second underlying substrate. The analysis instrument 1426 may further determine, for example, based on predetermined pedestal heights and the detected air gap widths (d), any misalignment between the substrate 100A and the second underlying substrate 200A. It should be appreciated that the alignment/misalignment detection system 1414 may be described as comprising upstream components for interacting with the light and system features in the incidence phase and downstream components for interacting with the light and system features in the detection phase. The example alignment/misalignment detection system 1414A may comprise one or more additional components, and/or one or more components of alignment/misalignment detection system 1414A may be omitted. Additionally or alternatively, one or more components of alignment/misalignment detection system 1414A may be rearranged.

FIG. 14B depicts an example alignment/misalignment detection system 1414B and method for measuring substrate misalignment. Alignment/misalignment detection system 1414B of FIG. 14B is substantially similar to alignment/misalignment detection system 1414A of FIG. 14A unless as explicitly described herein. Alignment/misalignment detection system 1414B may comprise (e.g., in addition to the features of FIG. 14A) a filter 1428, for example, between the light source 1418 and the substrate package 116A. The incident light 1420 may be passed through the filter 1428, for example, prior to being directed to the substrate package 116A. The filter 1428 may be used to control the wavelength of the incident light 1420. For example, some wavelengths of incident light 1420 may produce, for example, via thin film interferences, more easily detectable or processed reflected light 1422. Additionally or alternatively, the alignment/misalignment detection system 1414B may be used for misalignment measurements at various incident light 1420 wavelengths. The different determinations can be compared to refine measurement precision and error analysis. The example alignment/misalignment detection system 1414B may comprise one or more additional components, and/or one or more components of alignment/misalignment detection system 1414B may be omitted. Additionally or alternatively, one or more components of alignment/misalignment detection system 1414B may be rearranged.

FIG. 14C depicts an example alignment/misalignment detection system 1414C and method for measuring substrate misalignment. Alignment/misalignment detection system 1414C of FIG. 14C may be substantially similar to alignment/misalignment detection system 1414A of FIG. 14A and/or alignment/misalignment detection system 1414B of FIG. 14B unless explicitly described herein. Alignment/misalignment detection system 1414B may comprise a beam splitter 1430. The incident light 1420 may be passed through the beam splitter 1430, for example, prior to (e.g., upstream) from the substrate package 116A. Additionally or alternatively, the reflected light 1422 may be passed through the beam splitter 1430 downstream from the substrate package 116A. The beam splitter 1430 may enable further control of the incident light 1420 and/or the reflected light 1422, for example, to enable additional control of the misalignment measurement system. The alignment/misalignment detection system 1414C may further comprise one or more lenses 1432. The lens(es) 1432 may be configured to act on the incident light 1420, for example, upstream from the substrate package 116A. Additionally or alternatively, the lens(es) 1432 may be configured to act on the reflected light 1422, for example, downstream from the substrate package 116A and prior to detection and analysis. Additionally or alternatively, a filter 1428 may be used downstream from the substrate package 116A. For example, the filter 1428 may be disposed between the beam splitter 1430 and the sensor 1424. Filtering the reflected light 1422 may allow for further control and refinement of the detection side of the alignment/misalignment detection system 1414.

As described, one or more features of the alignment/misalignment detection systems 141A-1414E of FIGS. 14A-14E may be omitted and/or rearranged. FIG. 14D depicts an alternative example alignment/misalignment detection system 1414D and method for measuring substrate misalignment. Alignment/misalignment detection system 1414D of FIG. 14D may be substantially similar to alignment/misalignment detection system 1414A of FIG. 14A, alignment/misalignment detection system 1414B of FIG. 14B, and/or alignment/misalignment detection system 1414C of FIG. 14C unless as explicitly described herein. In the example alignment/misalignment detection system 1414C, the filter 1428 is depicted as being placed downstream from the substrate package 116A, for example, to control and/or manipulate the reflected light 1422. Additionally or alternatively, and as depicted in FIG. 14D, the filter 1428 may be disposed upstream from the substrate package 116A, for example, to control and/or manipulate the incident light 1420. For example, the filter 1428 may be disposed between the light source 1418 and the beam splitter 1430.

Example alignment/misalignment detection systems 1414 may include one or more additional features. FIG. 14E depicts an alternative example alignment/misalignment detection system 1414E and method for measuring substrate misalignment. Alignment/misalignment detection system 1414E of FIG. 14E may be substantially similar to alignment/misalignment detection system 1414A of FIG. 14A, alignment/misalignment detection system 1414B of FIG. 14B, alignment/misalignment detection system 1414C of FIG. 14C, and/or alignment/misalignment detection system 1414D of FIG. 14D unless as explicitly described herein. Alignment/misalignment detection system 1414E may comprise a spectrometer 1434. The spectrometer 1434 may be disposed downstream from the substrate package 116A. The spectrometer may be disposed between the beam splitter 1430 and the analysis instrument 1426. Alternatively, the spectrometer 1434 may be disposed, for example, between any two components downstream from the substrate package 116A. The spectrometer 1434 may be used to analyze the reflected wavelength(s) and/or light spectrum from the substrate package 116A. The spectrometer 1434 may be used to measure the intensity of the reflected light 1422, for example, across different wavelengths. The spectrometer 1434 may allow the alignment/misalignment detection system 1414E to determine and/or detect the composition of the reflected light 1422 assisting in the analysis and substrate misalignment detection. Similar to that which is described herein, the alignment/misalignment detection system 1414E may use filter 1428, for example, upstream from the substrate package 116A (e.g., between the light source 1418 and the beam splitter (and as depicted with incident light 1420A)). Additionally or alternatively, the filter 1428 may be omitted (e.g., as depicted with incident light 1420B). Additionally or alternatively, the filter 1428 may be disposed downstream from the substrate package 116A as described herein.

The depicted and described combinations and use of the light source 1418, the sensor 1424, the analysis instrument 1426, the filter 1428, the beam splitter 1430, the lens 1432, and the spectrometer 1434 may be further arranged in other combinations and/or orders for detecting and/or determining misalignment of the substrate 100 in relation to the underlying second substrate 202.

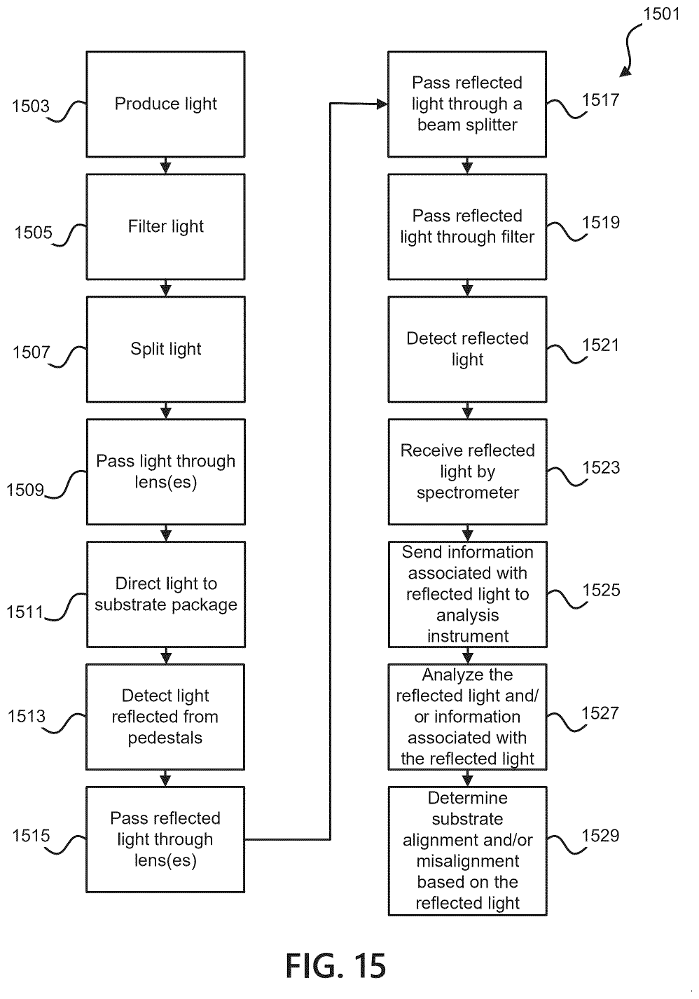

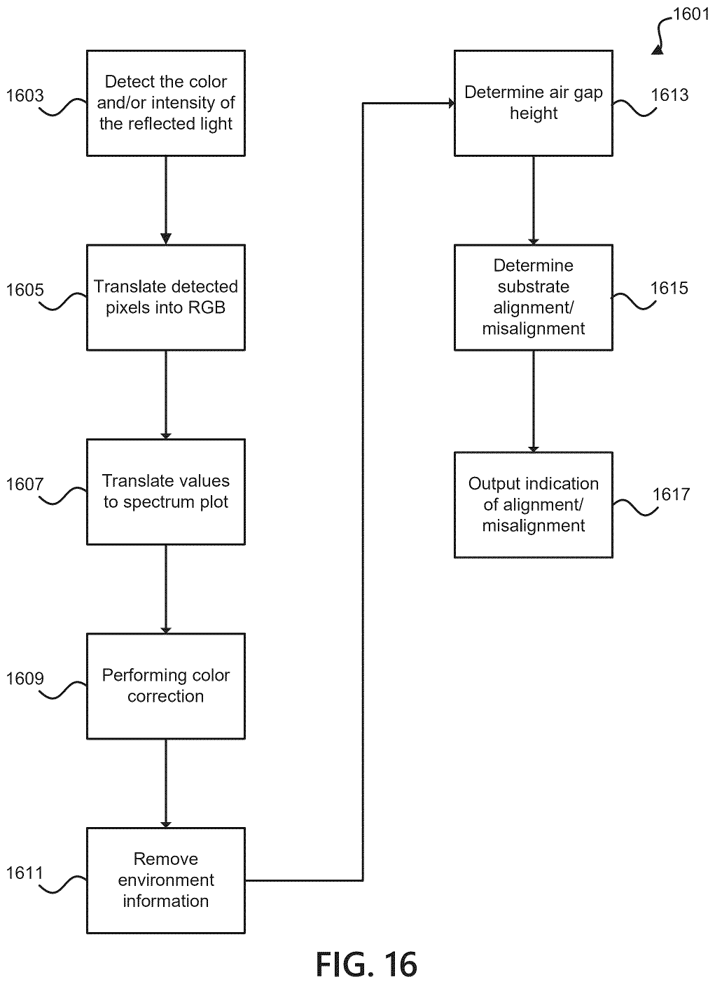

FIG. 15 depicts an example method 1501 associated with substrate misalignment detection. The example method 1501 of FIG. 15 may be executed by one or more components of one or more of the alignment/misalignment detection systems 1414A-1414E of FIGS. 14A-14E. At step 1503, a light source (e.g., the light source 1418) may produce a light, for example, a light beam. The light may be directed to and/or made to be incident on a substrate package (e.g., substrate package 116A). The substrate package may include a (e.g., substrate 100) and a packaged (e.g., engaged) second underlying substrate (e.g., second underlying substrate 202).

Additionally or alternatively, the light may be variously processed, transformed, and/or manipulated, for example, prior to being made incident on the substrate package. For example, at step 1505, the light may be filtered. For example, the light may be passed through a filter (e.g., filter 1428). Passing the light through the filter may result in filtering one or more wavelengths from the light produced at the light source.

Additionally or alternatively, at step 1507, the light (e.g., prior to being made incident on the substrate package) may be split. For example, the light may be passed through a beam splitter (e.g., beam splitter 1430).

Additionally or alternatively, at step 1509, the light (e.g., prior to being made incident on the substrate package) may be passed through one or more lenses (e.g., lens 132).

At step 1511, the light may be directed to and or made to be incident on the substrate package. The substrate package may be configured to achieve thin-film interference. For example, the substrate package, at one or more pedestals of a first substrate, may be configured to achieve thin-film interference, for example, between the one or more pedestals and one or more second underlying substrates (e.g., as described herein). The substrate package may reflect light and/or a spectrum of light. The reflected light may comprise light that has been manipulated via thin-film interference.

At step 1513, the reflected light, for example, from one or more pedestals of the substrate, may be detected, for example, as described in relation to alignment/misalignment detection systems 1414A-1414E of FIGS. 14A-14E. Additionally or alternatively, the reflected light may be processed, transformed, and/or manipulated prior to, during, or after being detected.

For example, at step 1515, the reflected light may be passed through a lens (e.g., lens 1432). Additionally or alternatively, at step 1517, the reflected light may be passed through a beam splitter (e.g., beam splitter 1430). Additionally or alternatively, at step 1519, the reflected light may be passed through a filter (e.g., filter 1428).

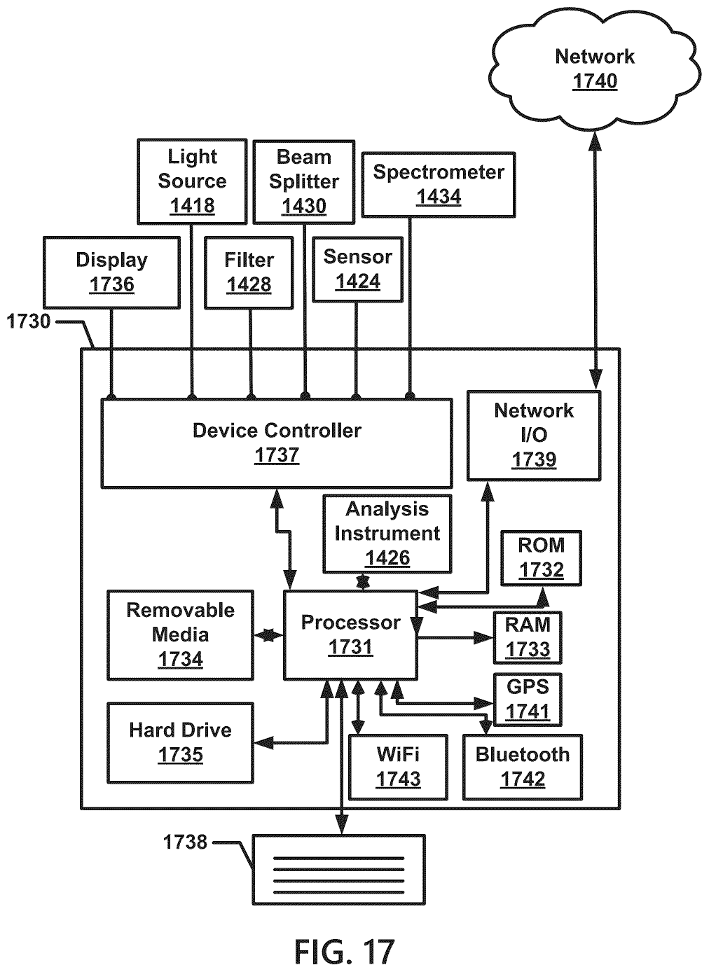

At step 1521, the reflected light may be sensed, scanned, and/or detected. For example, a sensor (e.g., sensor 1424) may be used to sense, scan, and/or detect the reflected light. Additionally or alternatively, at step 1523, the reflected light may be received by a spectrometer (e.g., spectrometer 1434). The spectrometer may be used to analyze the reflected light. Additionally or alternatively, at step 1525, the sensor and/or the spectrometer may send information, for example, to an analysis instrument (e.g., analysis instrument 1426) associated with the received, sensed, scanned, and/or detected light analyze (and/or further analyze) the reflected light. The analysis instrument may comprise a computing device (e.g., computing device 1730) or a portion thereof, for example, as described with reference to FIG. 17. At step 1527, the analysis instrument (e.g., analysis instrument 1426) may analyze/further analyze the reflected light, the detected light, and/or the information associated with the reflected light. At step 1529, the analysis instrument may determine (e.g., measure), for example, based on the reflected light and/or the detected light, an alignment and/or misalignment of the substrate in relation to an underlying second substrate.

FIG. 16 depicts an example method 1601 associated with substrate misalignment detection. The example method of FIG. 16 may be associated with air gap height extraction and/or determination. The example method 1601 of FIG. 16 may be executed by, for example, one or more components of one or more of alignment/misalignment detection systems 1414A-1414E of FIGS. 14A-14E. For example, the example method 1601 may be executed by one or more of sensor 1424, spectrometer 1434, and/or analysis instrument 1426. The example method of FIG. 16 may comprise one or more of steps 1521-1529 of the example method 1501 of FIG. 15.

Referring to FIG. 16, at step 1603, the color and/or intensity of the reflected light may be detected and/or measured. For example, the color and/or intensity of the reflected light may be measured for each pedestal in the sample (e.g., on substrate 100). Additionally or alternatively, the color and/or intensity of one or more of each detected pixel reflected from the substrate package may be measured.

At step 1605, each pixel, for example, detected and/or measured at step 1603, may be translated into Red, Green, and Blue (RGB) values. The RGB values (e.g., 0-255) may represent the intensity of each of the red, green, and blue colors that make up each pixel.

At step 1607, the RGB values, for example, determined and/or measured in step 1605, may be translated to a spectrum plot (e.g., intensity vs. wavelength).

At step 1609, the detected colors and/or the translated spectrum plots may be corrected. For example, the analysis instrument may perform color correction on one or more of the detected pixels and/or one or more determined spectrum plots.

At step 1611, the spectrum plots, for example, determined in step 1609, may be processed to remove environment information from the spectrum. For example, the spectrum plots may be processed to remove, for example, the illumination spectrum effect. Additionally or alternatively, the spectrum plots may be processed to remove effects from reflections off of the substrate.

At step 1613, the air gap height (d) may be determined (e.g., calculated) (e.g., as described herein). For example, for one or more of each determined and processed spectrum plot (e.g., for one or more of each detected and/or measured pixel), the air gap (d) may be determined. For example, the air gap (d) may be determined that produces the detected, processed, and/or extracted spectrum plot.

At step 1615, the alignment/misalignment of the substrate, for example, in relation to a second underlying substrate, may be determined. For example, the air gaps (d) determined in step 1613 may be compared with the known pedestal heights. Discrepancies, and/or lack thereof, between the expected air gap and the determined air gap, may be correlated to a map of the substrate alignment/misalignment.

At step 1617, an indication of the alignment/misalignment may be output (e.g., via display 1736) or sent for output. For example, the analysis device (e.g., computing device 1730) may be output values indicating alignment/misalignment. For example, the analysis device may output values indicating a z-offset between the substrate and the second underlying substrate. Additionally or alternatively, the analysis device may output an indication of a tilt (e.g., in radians, milliradians, etc.) of the substrate in relation to the underlying substrate. Additionally or alternatively, for example, where the substrate misalignment is used for quality control, the analysis device may output an indication of misalignment pass or fail. Additionally or alternatively, the analysis device may output a graphic of the substrate, and in some examples the second underlying substrate, indicating the alignment/misalignment between the substrates.

It will be appreciated by considering the present disclosure that aspects of the apparatuses, systems, and methods described herein may be used in several technological fields. For example aspects of the present alignment/misalignment detection techniques may be used in any technological field in which it is desirable to determine the alignment/misalignment of a substrate. For example, aspects of the present disclosure may be used in computing (e.g., optical computing), for example, to determine if a first substrate is aligned, for example, with a second substrate. Additionally, aspects of the present disclosure may be used in optical communications and/or optical computing. For example, in optical communications/computing it may be desirable to align substrates and/or components to ensure optical operability with minimized attenuation. Aspects of the present disclosure may be used to assist manufacturing and testing of such components. Proper alignment may facilitate realization of these goals. Further, aspects of the present disclosure may be used in manufacturing of various products and/or components. For example, the techniques described herein may be used in semiconductor manufacturing. For example, the techniques described herein may be used to determine alignment/misalignment of photolithography masks. Aspects of the present disclosure may be used to determine alignment in micromechanical systems (MEMS), where, for example, alignment may be desired. Aspects of the present disclosure may be used in other manufacturing/fabrication processes, for example, in solar cell manufacturing (e.g., multi-junction solar cells), printed circuit board (PCB) fabrication (e.g., for layer alignment). Additionally, aspects of the present disclosure may be used in 3D printing, for example, to determine whether the print bed is aligned (e.g., level). The above examples are not intended to be limiting but merely provided as examples of the advantages and applicability of the features described herein.

FIG. 17 shows example elements of a computing device that may be used to implement any of the various devices described herein, including, for example, analysis instrument 1426, and/or any computing device described herein. The computing device 1730 may include one or more processors 1731, which may execute instructions stored in the random-access memory (RAM) 1733, the removable media 1734 (such as a Universal Serial Bus (USB) drive, compact disk (CD) or digital versatile disk (DVD), or floppy disk drive), or any other desired storage medium. Instructions may also be stored in an attached (or internal) hard drive 1735. The computing device 1730 may also include a security processor (not shown), which may execute instructions of one or more computer programs to monitor the processes executing on the processor 1731 and any process that requests access to any hardware and/or software components of the computing device 1730 (e.g., ROM 1732, RAM 1733, the removable media 1734, the hard drive 1735, the device controller 1737, a network interface 1739, a GPS 1741, a Bluetooth interface 1742, a WiFi interface 1743, etc.). The computing device 1730 may include one or more output devices, such as the display 1736 (e.g., a screen, a display device, a monitor, a television, etc.), and may include one or more output device controllers 1737, such as a video processor. There may also be one or more user input devices 1738, such as a remote control, keyboard, mouse, touch screen, microphone, etc. The computing device 1730 may also include one or more network interfaces, such as a network interface 1739, which may be a wired interface, a wireless interface, or a combination of the two. The network interface 1739 may provide an interface for the computing device 1730 to communicate with a network 1740 (e.g., a RAN, or any other network). The network interface 1739 may include a modem (e.g., a cable modem), and the external network 1740 may include communication links, an external network, an in-home network, a provider's wireless, coaxial, fiber, or hybrid fiber/coaxial distribution system (e.g., a DOCSIS network), or any other desired network. Additionally, the computing device 1730 may include a location-detecting device, such as a global positioning system (GPS) microprocessor 1741, which may be configured to receive and process global positioning signals and determine, with possible assistance from an external server and antenna, a geographic position of the computing device 1730.

The example in FIG. 17 may be a hardware configuration, although the components shown may be implemented as software as well. Modifications may be made to add, remove, combine, divide, etc. components of the computing device 1730 as desired. Additionally, the components may be implemented using basic computing devices and components, and the same components (e.g., processor 1731, ROM storage 1732, display 1736, etc.) may be used to implement any of the other computing devices and components described herein. For example, the various components described herein may be implemented using computing devices having components such as a processor executing computer-executable instructions stored on a computer-readable medium, as shown in FIG. 17. Some or all of the entities described herein may be software-based, and may co-exist in a common physical platform (e.g., a requesting entity may be a separate software process and program from a dependent entity, both of which may be executed as software on a common computing device).

Additionally or alternatively, one or more of the upstream and/or downstream components and features of alignment/misalignment detection system 1414A-1414E of FIGS. 14A-14E may be included in, connected to, and/or implemented by computing device 1730. For example, one or more of light source 1418, filter 1428, sensor 1424, beam splitter 1430, spectrometer 1434, and analysis instrument 1426 may be included in, connected to, implemented by, and/or controlled by computing device 1730. One or more of these components may be connected to the computing device via device controller 1737.

One or more examples herein may be described as a process which may be depicted as a flowchart, a flow diagram, a data flow diagram, a structure diagram, and/or a block diagram. Although a flowchart may describe operations as a sequential process, one or more of the operations may be performed in parallel or concurrently. The order of the operations shown may be re-arranged. A process may be terminated when its operations are completed, but could have additional steps not shown in a figure. A process may correspond to a method, a function, a procedure, a subroutine, a subprogram, etc. If a process corresponds to a function, its termination may correspond to a return of the function to the calling function or the main function.

Operations described herein may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium. A processor(s) may perform the necessary tasks. Features of the disclosure may be implemented in hardware using, for example, hardware components such as application-specific integrated circuits (ASICs) and gate arrays. Implementation of a hardware state machine to perform the functions described herein will also be apparent to persons skilled in the art.

What is claimed is:

1. An apparatus comprising:
a substrate comprising a plurality of pedestals, each of the plurality of pedestals having predefined heights;
a portion of the plurality of pedestals being configured to engage and distance the substrate from an underlying second substrate;
the plurality of pedestals being further configured to indicate an alignment of the substrate with the underlying second substrate based on a spectrum of light detectable from the plurality of pedestals.

2. The apparatus of claim 1, wherein the substrate comprises a substantially transparent substrate.

3. The apparatus of claim 1, wherein the substrate and the plurality of pedestals comprise glass.

4. The apparatus of claim 3, wherein the second substrate comprises a silicon substrate.

5. The apparatus of claim 1, wherein a first portion of the plurality of pedestals are different heights from a second portion of the plurality of pedestals.

6. The apparatus of claim 1, wherein the substrate is further configured to use thin-film interference to indicate the alignment.

7. The apparatus of claim 1, wherein the alignment comprises a tilt with respect to the underlying second substrate.

8. The apparatus of claim 7, wherein the tilt comprises a tilt in a single axis.

9. The apparatus of claim 8, wherein the tilt comprises a tilt in multiple axes.

10. The apparatus of claim 1, wherein the alignment comprises a warp of the substrate.

11. The apparatus of claim 10, wherein the warp comprises a warp in relation to the underlying second substrate.

12. The apparatus of claim 1, wherein a portion of the plurality of pedestals are configured to emit different wavelengths of light based on being differently distanced from the underlying second substrate.

13. The apparatus of claim 1, wherein the plurality of pedestals comprise predefined heights.

14. The apparatus of claim 1, wherein the plurality of pedestals have substantially similar heights.

15. An apparatus comprising:
a substantially transparent substrate comprising a plurality of pedestals, each of the plurality of pedestals having predetermined heights;
the plurality of pedestals further configured to reflect a wavelength of light based on a distance from a second substrate.

16. The apparatus of claim 15, wherein a first portion of the plurality of pedestals are different heights from a second portion of the plurality of pedestals.

17. The apparatus of claim 15, wherein the substantially transparent substrate is further configured to use thin-film interference to indicate an alignment of the substantially transparent substrate with respect to the second substrate.

18. The apparatus of claim 15, wherein the plurality of pedestals comprise predefined heights.

19. An apparatus comprising:
a substantially transparent substrate configured to indicate a tilt of the substantially transparent substrate, the substantially transparent substrate comprising:
a plurality of pedestals, each of the plurality of pedestals having predefined heights;
a portion of the plurality of pedestals configured to interact with a second substrate to distance the substantially transparent substrate from the second substrate.

20. The apparatus of claim 19, wherein the substantially transparent substrate is further configured to use thin-film interference to indicate an alignment of the substantially transparent substrate with respect to the second substrate.
